(19) United States
(12) Patent Application Publication
(10) Pub. No.: US 2025/0300587 A1
(43) Pub. Date: Sep. 25, 2025

(54) ROTATING MACHINE CONTROL DEVICE

(71) Applicant: Mitsubishi Electric Corporation, Tokyo (JP)

(72) Inventors: Daisuke SATO, Tokyo (JP); Yuya TSUCHIMOTO, Tokyo (JP); Yasufumi OGAWA, Tokyo (JP); Masafumi YOSHIMATSU, Tokyo (JP)

(73) Assignee: Mitsubishi Electric Corporation, Tokyo (JP)

(21) Appl. No.: 18/862,359

(22) PCT Filed: Oct. 27, 2022
(86) PCT No.: PCT/JP2022/040072

§ 371 Date: Nov. 1, 2024

(30) Foreign Application Priority Data
Jun. 2, 2022 (JP) 2022-090026

(51) Int. Cl. H02P 27/08; H02M 7/5395; H02P 21/18

(52) U.S. Cl. CPC H02P 27/08; H02M 7/5395; H02P 21/18

(57) ABSTRACT

An inverter control unit of a rotating machine control device includes a three-phase voltage command correction determination unit which determines a correction method for a three-phase voltage command, and-a three-phase voltage command correction unit which corrects the three-phase voltage command on the basis of a correction determination result. In a case where the voltage phase is determined to be a “zero-voltage phase”, the three-phase voltage command correction unit performs correction of adding or subtracting a three-phase voltage command correction amount to or from the three-phase voltage command. In a case where the voltage phase is determined to be a “positive-voltage phase” or a “negative-voltage phase”, the three-phase voltage command correction unit corrects the three-phase voltage command to such a value that a duty becomes 100% or greater or becomes 0% or smaller.

### TECHNICAL FIELD

The present disclosure relates to a rotating machine control device.

### BACKGROUND ART

As a method for controlling a rotating machine, a pulse width modulation (PWM) control method is generally known. As a method for increasing the voltage utilization rate in the PWM control method, rectangular wave control which makes output voltage into a rectangular wave shape is widely known. In the rectangular wave control, ON and OFF of the rectangular wave voltage are switched to apply desired three-phase voltage for each phase. Therefore, the three-phase voltage is adjusted by adjusting the timing of switching ON and OFF of the rectangular wave voltage.

As an adjustment method for the three-phase voltage, a method of adjusting the voltage phase of a three-phase voltage command is used. For example, Patent Document 1 discloses that, for a voltage command for each phase of a three-phase voltage command in rectangular wave control, a change amount of the voltage phase is equally increased/decreased in every switching, whereby the voltage phase of the voltage command for each phase is adjusted.

### CITATION LIST

### Patent Document

Patent Document 1: Japanese Laid-Open Patent Publication No. 2009-95144

### SUMMARY OF THE INVENTION

### Problem to be Solved by the Invention

However, in a case of adjusting output voltage by adjusting the voltage phase for each phase as described above, the calculation amount per cycle needs to be increased to an extent corresponding to the resolution of the adjustment amount for the voltage phase. For example, in order to operate voltage phases by 10°, calculation needs to be performed 36 (360/10=36) times during one cycle of electric angle (360°). When the calculation amount per one cycle increases, the processing load increases. Accordingly, a calculation device such as a microcomputer is required to be enhanced in performance. Enhancing performance of the calculation device leads to increase in cost.

The present disclosure has been made to solve the above problem, and an object of the present disclosure is to provide a rotating machine control device that can adjust ON/OFF switchover timings of rectangular wave voltage while preventing increase in a calculation amount.

### Means to Solve the Problem

A rotating machine control device according to the present disclosure is a rotating machine control device which controls a rotating machine by applying rectangular wave voltage to the rotating machine, the rotating machine control device including: an inverter which converts DC power and outputs the rectangular wave voltage; an inverter control unit which generates a rectangular-wave-shaped switching pattern for controlling the inverter; and a rotation position detection unit which detects a rotation position of the rotating machine. The inverter control unit includes: a two-phase/three-phase conversion unit which, on the basis of the rotation position, converts a dq-axis voltage command to a three-phase voltage command and calculates a voltage phase of the three-phase voltage command; a three-phase voltage command normalization unit which normalizes the three-phase voltage command, to calculate a duty; a three-phase voltage command correction amount calculation unit which calculates a three-phase voltage command correction amount; a carrier wave generation unit which generates a carrier wave having a frequency that is an odd multiple of an electric angle frequency of the rotating machine; and a switching pattern generation unit which generates the switching pattern by comparing the duty with the carrier wave. The inverter control unit determines a correction method for the duty in accordance with which the voltage phase is among a zero-voltage phase which is the voltage phase when the three-phase voltage command is determined to be zero, a positive-voltage phase which is the voltage phase when the three-phase voltage command is determined to be positive, and a negative-voltage phase which is the voltage phase when the three-phase voltage command is determined to be negative. In a case where the voltage phase is determined to be the zero-voltage phase, the inverter control unit performs correction of offsetting the duty in an amplitude direction on the basis of the three-phase voltage command correction amount. In a case where the voltage phase is determined to be the positive-voltage phase, the inverter control unit performs correction of making the duty be 100% or greater. In a case where the voltage phase is determined to be the negative-voltage phase, the inverter control unit performs correction of making the duty be 0% or smaller.

Another rotating machine control device according to the present disclosure is a rotating machine control device which controls a rotating machine by applying rectangular wave voltage to the rotating machine, the rotating machine control device including: an inverter which converts DC power and outputs the rectangular wave voltage; an inverter control unit which generates a rectangular-wave-shaped switching pattern for controlling the inverter; and a rotation position detection unit which detects a rotation position of the rotating machine. The inverter control unit includes: a two-phase/three-phase conversion unit which, on the basis of the rotation position, converts a dq-axis voltage command to a three-phase voltage command and calculates a voltage phase of the three-phase voltage command; a three-phase voltage command normalization unit which normalizes the three-phase voltage command, to calculate a duty; a three-phase voltage command correction amount calculation unit which calculates a three-phase voltage command correction amount; a first three-phase voltage command correction unit which performs correction of offsetting the three-phase voltage command in an amplitude direction on the basis of the three-phase voltage command correction amount, to calculate a first corrected three-phase voltage command; a carrier wave generation unit which generates a carrier wave having a frequency that is an odd multiple of an electric angle frequency of the rotating machine; and a switching pattern generation unit which generates the switching pattern by comparing the duty with the carrier wave. The inverter control unit determines a correction method for the duty in accordance with which the voltage phase is among a zero-voltage phase which is the voltage phase when the first corrected three-phase voltage command is determined to be zero, a positive-voltage phase which is the voltage phase when the first corrected three-phase voltage command is determined to be positive, and a negative-voltage phase which is the voltage phase when the first corrected three-phase voltage command is determined to be negative. In a case where the voltage phase is determined to be the zero-voltage phase, the inverter control unit does not correct the duty. In a case where the voltage phase is determined to be the positive-voltage phase, the inverter control unit performs correction of making the duty be 100% or greater. In a case where the voltage phase is determined to be the negative-voltage phase, the inverter control unit performs correction of making the duty be 0% or smaller.

### Effect of the Invention

The rotating machine control device according to the present disclosure can adjust ON/OFF switchover timings of rectangular wave voltage while preventing increase in a calculation amount.

### BRIEF DESCRIPTION OF THE DRAWINGS

FIG. 1 is a configuration diagram showing a rotating machine control device according to embodiment 1.

FIG. 2 illustrates dq-axis voltage phase according to embodiment 1.

FIG. 3 illustrates correction determination for a three-phase voltage command according to embodiment 1.

FIG. 4 shows the relationship between the three-phase voltage command and a duty according to embodiment 1.

FIG. 5 shows an example of correction of the three-phase voltage command according to embodiment 1 and illustrates correction of making the duty be 100% or greater or be 0% or smaller.

FIG. 6 shows an example of correction of the three-phase voltage command according to embodiment 1 and illustrates correction of making the duty be 100% or greater or be 0% or smaller.

FIG. 7 shows an example of correction of the three-phase voltage command according to embodiment 1 and illustrates correction of making the duty be 100% or greater or be 0% or smaller.

FIG. 8 shows an example of the relationship among a duty, a carrier wave, and a switching pattern according to embodiment 1, in a case where the duty is calculated without correction of the three-phase voltage command.

FIG. 9 shows an example of the relationship among a duty, a carrier wave, and a switching pattern according to embodiment 1, in a case where the duty is calculated with the three-phase voltage command corrected.

FIG. 10 shows an example of the relationship among a duty, a carrier wave, and a switching pattern according to embodiment 1, in a case where the duty is calculated with the three-phase voltage command corrected and correction is performed to adjust ON/OFF switchover timings of rectangular wave voltage.

FIG. 11 shows the relationship among a duty, a carrier wave, and a switching pattern in a case where rectangular wave control is performed with a carrier wave frequency set to be an even multiple of an electric angle frequency.

FIG. 12 shows an example of a hardware configuration of an inverter control unit according to embodiment 1.

FIG. 13 is a flowchart showing operation of the rotating machine control device according to embodiment 1.

FIG. 14 illustrates an example in which the three-phase voltage command before correction is normalized to calculate a pre-correction duty and then correction is performed on the pre-correction duty, in embodiment 1.

FIG. 15 shows an example of the relationship among a duty, a carrier wave, and a switching pattern according to modification 1 of embodiment 1.

FIG. 16 is a configuration diagram showing a rotating machine control device according to embodiment 2.

FIG. 17 illustrates correction determination for a first corrected three-phase voltage command according to embodiment 2.

FIG. 18 shows an example of the relationship among a duty, a carrier wave, and a switching pattern according to embodiment 2, in a case where the duty is calculated without correction of the first corrected three-phase voltage command.

FIG. 19 shows an example of the relationship among a duty, a carrier wave, and a switching pattern according to embodiment 2, in a case where the duty is calculated with the first corrected three-phase voltage command corrected.

FIG. 20 illustrates an example in which the three-phase voltage command before correction is normalized to calculate a pre-correction duty and then correction is performed on the pre-correction duty, in embodiment 2.

FIG. 21 illustrates an example in which the first corrected three-phase voltage command is normalized to calculate a first corrected duty and then correction is further performed on the first corrected duty, in embodiment 2.

### DESCRIPTION OF EMBODIMENTS

### Embodiment 1

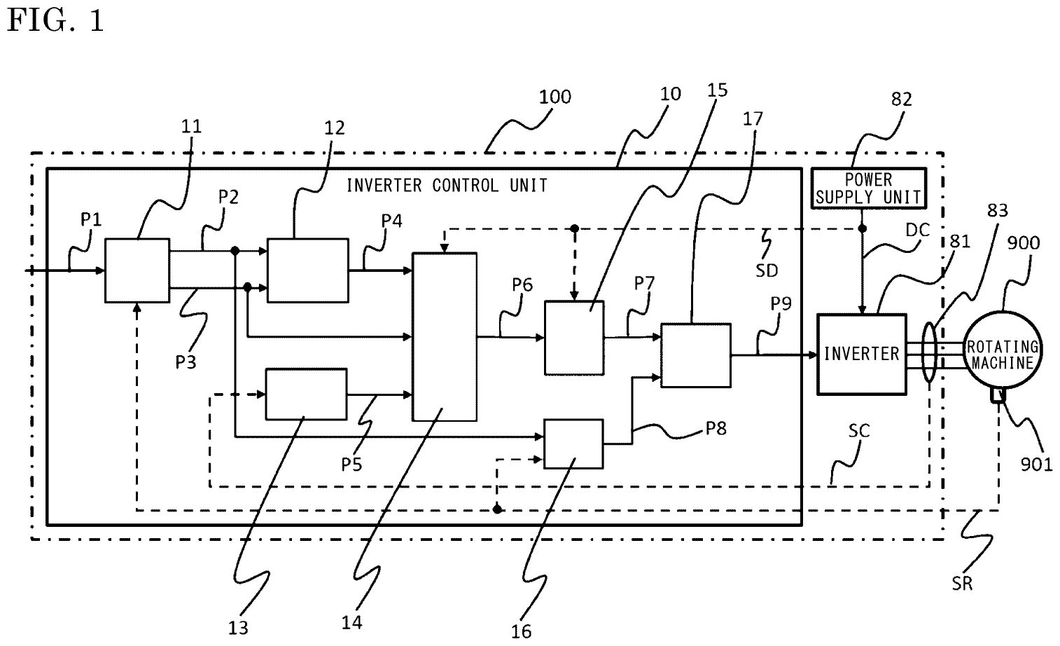

Embodiment 1 will be described with reference to FIG. 1 to FIG. 14. FIG. 1 is a configuration diagram showing a rotating machine control device according to embodiment 1. A rotating machine control device 100 is for controlling a rotating machine 900 in accordance with a dq-axis voltage command P1, and includes an inverter control unit 10, an inverter 81 which is controlled by the inverter control unit 10 and applies three-phase AC voltages to the rotating machine 900, and a power supply unit 82 which supplies DC power DC to the inverter 81. An output current detection unit 83 for detecting three-phase currents flowing between the inverter 81 and the rotating machine 900 is provided at an electric path connecting the inverter 81 and the rotating machine 900.

The inverter 81 is a power conversion unit which converts DC power DC supplied from the power supply unit 82 to AC power. The inverter 81 includes a plurality of switching elements (not shown), and the switching elements form a series circuit in which a positive-side switching element connected to the positive side of the power supply unit 82 which is a DC power supply and a negative-side switching element connected to the negative side of the power supply unit 82 are connected in series, correspondingly to a winding for each phase of the rotating machine 900. That is, a switching element for u phase, a switching element for v phase, and a switching element for w phase on the positive side, and a switching element for u phase, a switching element for v phase, and a switching element for w phase on the negative side, are respectively connected in series, to form arms corresponding to the respective phases, and a middle point (connection point) between two switching elements forming the arm for each phase is connected to the winding for the corresponding phase of the rotating machine 900. Each switching element of the inverter 81 is switched ON/OFF in accordance with a switching pattern P9, whereby the DC power DC supplied from the power supply unit 82 is converted to AC power and thus three-phase voltages which are three-phase AC voltages are outputted.

As the switching elements forming the inverter 81, for example, an insulated gate bipolar transistor (IGBT) to which a diode is connected in antiparallel, a bipolar transistor to which a diode is connected in antiparallel, or a metal oxide semiconductor field effect transistor (MOSFET), is used. A gate terminal of each switching element is connected to a PWM control unit 17 (i.e., a switching pattern generation unit) provided in the inverter control unit 10, via a gate driving circuit or the like (not shown). With this configuration, each switching element is switched ON/OFF by the PWM control unit 17 of the inverter control unit 10.

The power supply unit 82 supplies the DC power DC to the inverter 81, and transmits a DC voltage signal SD indicating DC voltage value Vdc of the power supply unit 82, to a three-phase voltage command correction unit 14 and a three-phase voltage command normalization unit 15 of the inverter control unit 10.

It suffices that the DC power DC can be supplied to the inverter 81, and therefore the power supply unit 82 may be replaced with an external DC power supply. In this case, a voltage detection unit is provided for detecting the DC voltage value Vdc and transmitting the DC voltage signal SD to the three-phase voltage command correction unit 14 and the three-phase voltage command normalization unit 15. The power supply unit 82 of embodiment 1 has both of a function as a power supply that supplies the DC power DC to the inverter 81, and a function as a voltage detection unit that detects the DC voltage value Vdc and transmits the DC voltage signal SD.

The output current detection unit 83 detects three-phase currents flowing between the inverter 81 and the rotating machine 900, and transmits a three-phase current signal SC indicating detected values of the three-phase currents, to a three-phase voltage command correction amount calculation unit 13 of the inverter control unit 10. The output current detection unit 83 may be configured to obtain detected values of the three-phase currents using sensors, or may be configured to estimate current values of the three-phase currents and use the estimated values as detected values, without using sensors.

The rotating machine 900 is a permanent magnet synchronous rotating machine having three-phase windings at a stator (not shown) and permanent magnets at a rotor (not shown), for example. The rotating machine 900 is driven with three-phase AC voltages applied by the inverter 81. The rotating machine 900 is provided with a rotation position detection unit 901 for detecting the rotation position of the rotating machine 900. The rotation position detection unit 901 is a rotation angle sensor formed by a resolver or an encoder, for example, and detects the rotation angle of the rotor of the rotating machine 900 as a rotation position. The rotation position detection unit 901 transmits a rotation position signal SR indicating the detected rotation position, to a two-phase/three-phase conversion unit 11 and a carrier wave generation unit 16 of the inverter control unit 10. As the rotating machine 900, an AC rotating machine other than a permanent magnet synchronous rotating machine may be applied.

The inverter control unit 10 is for controlling the inverter 81 on the basis of the dq-axis voltage command, and includes the two-phase/three-phase conversion unit 11 which calculates a voltage phase P2 and a three-phase voltage command P3 on the basis of the dq-axis voltage command P1 and the rotation position signal SR, the three-phase voltage command correction determination unit 12 (i.e., correction determination unit) which performs correction determination for the three-phase voltage command P3 on the basis of the voltage phase P2, the three-phase voltage command correction amount calculation unit 13 which calculates a three-phase voltage command correction amount P5 on the basis of a current value indicated by the three-phase current signal SC, and the three-phase voltage command correction unit 14 which calculates a corrected three-phase voltage command P6 on the basis of the three-phase voltage command P3, a correction determination result P4, the three-phase voltage command correction amount P5, and the DC voltage value Vdc indicated by the DC voltage signal SD. In addition, the inverter control unit 10 includes the three-phase voltage command normalization unit 15 which normalizes the corrected three-phase voltage command P6, to calculate a duty P7, the carrier wave generation unit 16 which generates a carrier wave P8 on the basis of the voltage phase P2 and a rotation position indicated by the rotation position signal SR, and the PWM control unit 17 which generates the switching pattern P9 on the basis of the duty P7 and the carrier wave P8. In the present disclosure, the “duty” refers to a value obtained by normalizing a voltage command, in particular, a three-phase voltage command. For discrimination, a duty obtained by normalizing the corrected three-phase voltage command P6 is referred to as the duty P7, but a value obtained by normalizing a three-phase voltage command before correction is also included as the “duty”.

The two-phase/three-phase conversion unit 11 receives the dq-axis voltage command P1 from an external host controller or the like, and receives the rotation position signal SR from the rotation position detection unit 901. The two-phase/three-phase conversion unit 11 performs coordinate conversion of the dq-axis voltage command P1 on the basis of the rotation position indicated by the rotation position signal SR, i.e., the rotation position of the rotating machine 900 detected by the rotation position detection unit 901, to calculate the three-phase voltage command P3. In addition, the two-phase/three-phase conversion unit 11 calculates the voltage phase P2 from the rotation position of the rotating machine 900. The two-phase/three-phase conversion unit 11 outputs the voltage phase P2 to the three-phase voltage command correction determination unit 12 and the carrier wave generation unit 16, and outputs the three-phase voltage command P3 to the three-phase voltage command correction determination unit 12 and the three-phase voltage command correction unit 14.

The dq-axis voltage command P1 is a voltage command represented in an orthogonal two-phase coordinate system, and is calculated from a torque command for the rotating machine 900 or a current command in an orthogonal two-phase coordinate system. In embodiment 1, calculation of the dq-axis voltage command P1 is performed by an external host controller or the like as described above. However, calculation of the dq-axis voltage command P1 may be performed in the inverter control unit 10. A calculation method for the dq-axis voltage command P1 is not particularly limited. As in feedforward control, the dq-axis voltage command P1 may be calculated from a current command using a voltage equation. Alternatively, the dq-axis voltage command P1 may be calculated through feedback control using PI control (proportional integral control) based on current flowing through the rotating machine 900.

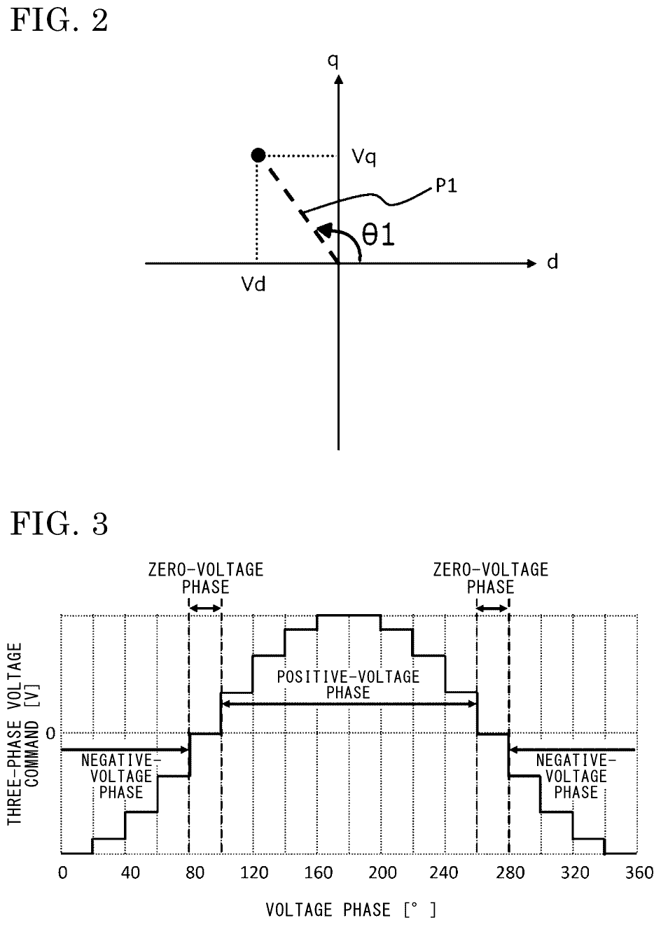

The dq-axis voltage command P1 includes a d-axis side voltage command Vd and a q-axis side voltage command Vq determined by a dq-axis voltage phase θ1 on a d-q plane. FIG. 2 illustrates the dq-axis voltage phase θ1 according to embodiment 1. The d-q plane is a plane formed by a d axis and a q axis having a phase difference of 90° in electric angle from the d axis, and the d axis corresponds to a magnetic pole direction of the rotor of the rotating machine 900. As shown in FIG. 2, the dq-axis voltage command P1 is set with the origin of the d-q plane as a reference, and the dq-axis voltage phase θ1 is set with a+d direction as a reference. Thus, the d-axis side voltage command Vd and the q-axis side voltage command Vq of the dq-axis voltage command P1 are calculated by the following Formulae (1) and (2).

$$Vd = V cos θ1 \qquad ( 1 )$$

$$Vd = V sin θ1 \qquad ( 2 )$$

Here, V is the amplitude of a voltage command for each phase.

The voltage phase P2 is a voltage phase of the three-phase voltage command P3. The voltage phase P2 is calculated on the basis of the dq-axis voltage phase θ1 and an electric angle Ge, and includes a voltage phase for u phase, a voltage phase for v phase, and a voltage phase for w phase. Hereinafter, the voltage phases for respective phases are referred to as a u-phase voltage phase θ2u, a v-phase voltage phase θ2v, and a w-phase voltage phase θ2w.

The three-phase voltage command P3 includes a voltage command for u phase, a voltage command for v phase, and a voltage command for w phase. Hereinafter, the voltage commands for respective phases are referred to as a u-phase voltage command Vu, a v-phase voltage command Vv, and a w-phase voltage command Vw.

The u-phase voltage command Vu is calculated by the following Formula (3).

$$Vu = V sin ( θ1 + θ e ) = V sin ( θ2 u ) \qquad ( 3 )$$

The v-phase voltage command Vv is calculated by the following Formula (4).

$$Vv = V sin ( θ1 + θ e + 2 / 3 \times π ) = V sin ( θ2 v ) \qquad ( 4 )$$

The w-phase voltage command Vw is calculated by the following Formula (5).

$$Vw = V sin ( θ1 + θ e - 2 / 3 \times π ) = V sin ( θ2 w ) \qquad ( 5 )$$

In Formulae (3), (4), and (5), the relationship between the dq-axis voltage phase θ1, and each of the u-phase voltage phase θ2u, the v-phase voltage phase θ2v, and the w-phase voltage phase θ2w, is also shown. That is, when the electric angle Ge is known, conversion between the dq-axis voltage phase θ1 and each of the u-phase voltage phase θ2u, the v-phase voltage phase θ2v, and the w-phase voltage phase θ2w can be performed.

The three-phase voltage command correction determination unit 12 receives the voltage phase P2 and the three-phase voltage command P3 from the two-phase/three-phase conversion unit 11. The three-phase voltage command correction determination unit 12 determines which the voltage phase P2 for each phase is among a “zero-voltage phase”, a “positive-voltage phase”, and a “negative-voltage phase”, and on the basis of the determination result, performs correction determination. The “zero-voltage phase” is a voltage phase at which the value of the three-phase voltage command for a determination target becomes zero. The “positive-voltage phase” is a voltage phase at which the value of the three-phase voltage command for a determination target becomes positive, and the “negative-voltage phase” is a voltage phase at which the value of the three-phase voltage command for a determination target becomes negative. As described below, the three-phase voltage command correction determination unit 12 performs determination for the value of the three-phase voltage command P3 on the basis of the voltage phase P2, and on the basis of the determination result, performs correction determination. The three-phase voltage command correction determination unit 12 outputs the correction determination result P4 indicating the result of the correction determination, to the three-phase voltage command correction unit 14.

Correction determination for the three-phase voltage command will be described. FIG. 3 illustrates correction determination for the three-phase voltage command according to embodiment 1, and shows an example of a determination result for a voltage phase for one phase among voltage commands for respective phases of the three-phase voltage command P3 in one cycle of electric angle (equal to one cycle of the three-phase voltage command). Regarding the voltage command for one phase, if the voltage phase thereof is 0° to 80° or 280° to 360°, the voltage phase is determined to be a “negative-voltage phase”, and if the voltage phase is 80° to 100° or 260° to 280°, the voltage phase is determined to be a “zero-voltage phase”. In addition, if the voltage phase is 100° to 260°, the voltage phase is determined to be a “positive-voltage phase”. In embodiment 1, a correction method is determined depending on which the voltage phase is determined to be among a “zero-voltage phase”, a “positive-voltage phase, and a “negative-voltage phase”, and on the basis of the determination for the voltage phase as described above, correction determination is performed. The three-phase voltage command correction determination unit 12 performs the above correction determination for each of u phase, v phase, and w phase.

The three-phase voltage command correction amount calculation unit 13 calculates the three-phase voltage command correction amount P5 which is a correction amount for adjusting a pulse width and a phase of rectangular wave voltage to be applied to the rotating machine 900. In embodiment 1, the three-phase voltage command correction amount calculation unit 13 receives the three-phase current signal SC from the output current detection unit 83, and the three-phase voltage command correction amount calculation unit 13 calculates the three-phase voltage command correction amount P5 on the basis of three-phase currents detected by the output current detection unit 83. The three-phase voltage command correction amount is calculated so as to reduce offset components of the three-phase currents. By suppressing occurrence of offset components of the three-phase currents, loss due to increase in peak current can be suppressed and a risk that current flowing through an element exceeds a current permissible value can be reduced. The three-phase voltage command correction amount calculation unit 13 outputs the three-phase voltage command correction amount P5 to the three-phase voltage command correction unit 14. The three-phase voltage command correction amount P5 includes a u-phase voltage command correction amount Vuo, a v-phase voltage command correction amount Vvo, and a w-phase voltage command correction amount Vwo which are correction amounts for voltage commands for respective phases, i.e., the u-phase voltage command Vu, the v-phase voltage command Vv, and the w-phase voltage command Vw.

Calculation of the three-phase voltage command correction amount will be described. As described above, the three-phase voltage command correction amount is calculated so as to reduce offset components of the three-phase currents. As a method for reducing offset components, there is a method in which an integral value of three-phase current is fed back so that the integral value of the three-phase current becomes close to zero.

In a case of u phase, the u-phase voltage command correction amount Vuo is calculated by the following Formula (6).

$$Vuo = K / s \times Iu \qquad ( 6 )$$

In Formula (6), K is an integral gain, s is a differential operator, and Iu is u-phase current of the three-phase currents. That is, the u-phase voltage command correction amount Vuo is calculated by integrating the u-phase current. While Formula (6) is directed to the u-phase voltage command correction amount Vuo, the same applies to the v-phase voltage command correction amount Vvo and the w-phase voltage command correction amount Vwo. In calculation of the v-phase voltage command correction amount Vvo and the w-phase voltage command correction amount Vwo, the u-phase current Iu in Formula (6) is replaced with each of the v-phase current Iv and the w-phase current Iw. The integral gain K may be a fixed value or may be changed in accordance with the rotation position of the rotating machine 900. In calculation of each of the u-phase voltage command correction amount Vuo, the v-phase voltage command correction amount Vvo, and the w-phase voltage command correction amount Vwo, the integral gain K may be made different. Although the method of calculating the three-phase voltage command correction amount using integral control is described here, offset components of the three-phase currents may be extracted using a high-pass filter or the like, and the three-phase voltage command correction amount may be determined so as to reduce offset components of the three-phase currents.

The three-phase voltage command correction unit 14 receives the correction determination result P4 from the three-phase voltage command correction determination unit 12, and the three-phase voltage command P3 from the two-phase/three-phase conversion unit 11. In addition, the three-phase voltage command correction unit 14 receives the three-phase voltage command correction amount P5 from the three-phase voltage command correction amount calculation unit 13. In addition, the three-phase voltage command correction unit 14 receives the DC voltage signal SD from the power supply unit 82. On the basis of the correction determination result P4, the three-phase voltage command correction unit 14 corrects the three-phase voltage command P3 using the three-phase voltage command correction amount P5 and the DC voltage value Vdc, to calculate the corrected three-phase voltage command P6. The three-phase voltage command correction unit 14 outputs the corrected three-phase voltage command P6 to the three-phase voltage command normalization unit 15. The corrected three-phase voltage command P6 also includes voltage commands for u phase, v phase, and w phase. These voltage commands are referred to as a corrected u-phase voltage command Vu*, a corrected v-phase voltage command Vv*, and a corrected w-phase voltage command Vw*.

In a case where the voltage phase P2 is determined to be a “zero-voltage phase”, the three-phase voltage command correction unit 14 adds or subtracts the three-phase voltage command correction amount P5 to or from the three-phase voltage command P3 so that offset components of the three-phase currents become close to zero. In a case of u phase, the corrected u-phase voltage command Vu* is calculated by the following Formula (7).

$${Vu}^{*} = Vu + Vuo \qquad ( 7 )$$

Here, since correction is performed so that offset components of the three-phase currents become close to zero, the right-hand side of Formula (7) may be represented as a subtraction expression (Vu−Vuo), depending on the signs of the u-phase voltage command Vu and the u-phase voltage command correction amount Vuo. The same applies to the corrected v-phase voltage command Vv* and the corrected w-phase voltage command Vw*. Correction of adding or subtracting the three-phase voltage command correction amount P5 to or from the three-phase voltage command P3 as described above corresponds to correction of offsetting, in an amplitude direction, the duty calculated when the three-phase voltage command P3 is normalized.

In a case where the voltage phase P2 is determined to be a “positive-voltage phase”, the three-phase voltage command correction unit 14 corrects the three-phase voltage command P3 so that the duty described later becomes 100% or greater.

In a case where the voltage phase P2 is determined to be a “negative-voltage phase”, the three-phase voltage command correction unit 14 corrects the three-phase voltage command P3 so that the duty described later becomes 0% or smaller.

The three-phase voltage command normalization unit 15 receives the corrected three-phase voltage command P6 from the three-phase voltage command correction unit 14 and the DC voltage signal SD from the power supply unit 82. The three-phase voltage command normalization unit 15 normalizes the corrected three-phase voltage command P6 for each phase, to make the magnitude of the corrected three-phase voltage command P6 constant irrespective of the magnitude of the DC power DC. Since the magnitude of the amplitude of the corrected three-phase voltage command P6 changes depending on the magnitude of the DC voltage value Vdc of the power supply unit 82, it is necessary to perform normalization, for comparison with the carrier wave P8 described later. The three-phase voltage command normalization unit 15 acquires the DC voltage value Vdc from the DC voltage signal SD, and normalizes the corrected three-phase voltage command P6 using the DC voltage value Vdc. The three-phase voltage command normalization unit 15 outputs the normalized corrected three-phase voltage command P6 as the duty P7, to the PWM control unit 17.

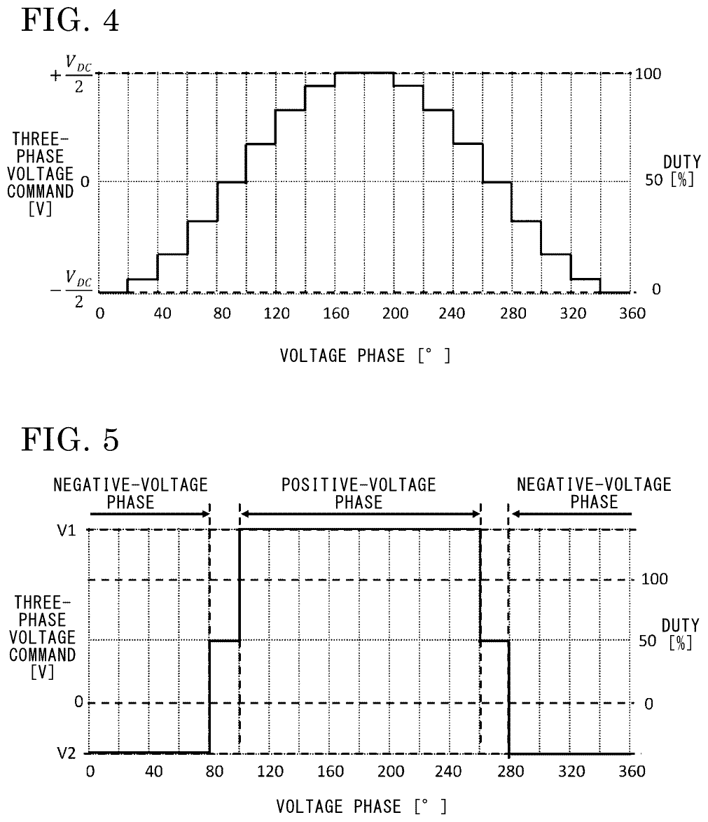

Normalization of the three-phase voltage command will be further described. FIG. 4 shows the relationship between the three-phase voltage command and the duty according to embodiment 1, and shows the relationship between the magnitude of the three-phase voltage command and the duty in one cycle of the three-phase voltage command. In FIG. 4, the wording “three-phase voltage command” is shown in order to indicate the correspondence between the “three-phase voltage command” and the “duty”. However, in actual calculation, the corrected three-phase voltage command is used. The “three-phase voltage command” and the “duty” in FIG. 4 represent those for any of u phase, v phase, and w phase. Here, description will be given for u phase as an example, but the same applies to v phase and w phase. The correspondence relationship between the u-phase voltage command Vu and a u-phase duty Du is as shown by the following Formula (8) using the DC voltage value Vdc.

$$Du = ( Vu / Vdc + 0.5 ) \times 100 ( \% ) \qquad ( 8 )$$

From Formula (8), values of the u-phase voltage command Vu in cases where the u-phase duty Du becomes 100% and 0% can be determined. These values are denoted by Vref_MAX and Vref_MIN, which are represented by the following Formulae (9) and (10).

$$Vref\_MAX = + Vdc / 2 \qquad ( 9 )$$

$$Vref\_MIN = - Vdc / 2 \qquad ( 10 )$$

It is found that, if Vu in Formula (8) is replaced with Vref_MAX, Du becomes 100%, and if Vu is replaced with Vref_MIN, Du becomes 0%. It is also found that, if Vu is 0, Du becomes 50%.

As described above, in correction of the three-phase voltage command P3 by the three-phase voltage command correction unit 14, in a case where the voltage phase P2 is determined to be a “positive-voltage phase”, the three-phase voltage command P3 is corrected so that the duty becomes 100% or greater. In a case of u phase, the corrected u-phase voltage command Vu* is corrected to a value not smaller than Vref_MAX (=+Vdc/2). In a case where the voltage phase P2 is determined to be a “negative-voltage phase”, the three-phase voltage command P3 is corrected so that the duty becomes 0% or smaller. In a case of u phase, the corrected u-phase voltage command Vu* is corrected to a value not greater than Vref_MIN (=−Vdc/2). As is found from the above, the DC voltage value Vdc is used for correction of the three-phase voltage command P3.

A method for correcting the duty to 100% or greater or to 0% or smaller will be described. FIG. 5 shows an example of correction of the three-phase voltage command according to embodiment 1, and illustrates correction of making the duty be 100% or greater or be 0% or smaller. In FIG. 5, a “zero-voltage phase” is not shown. The “three-phase voltage command” and the “duty” in FIG. 5 represent those for any of u phase, v phase, and w phase. As a method for correcting the duty P7 to 100% or greater in a case of “positive-voltage phase”, there is a method of correcting the three-phase voltage command P3 to a predetermined first voltage value V1. In this case, the first voltage value V1 is set to be greater than Vref_MAX in Formula (9). As an example, the first voltage value V1 may be set to be the DC voltage value Vdc or greater. In a case where the corrected three-phase voltage command P6 is calculated with the three-phase voltage command P3 corrected to the first voltage value V1, the duty P7 calculated from the corrected three-phase voltage command P6 becomes greater than 100%.

As a method for correcting the duty P7 to 0% or smaller in a case of “negative-voltage phase”, there is a method of correcting the three-phase voltage command P3 to a predetermined second voltage value V2. In this case, the second voltage value V2 is set to be smaller than Vref_MIN in Formula (10). As an example, the second voltage value V2 may be set to be −1 times the DC voltage value (i.e., −Vdc) or smaller. In a case where the corrected three-phase voltage command P6 is calculated with the three-phase voltage command P3 corrected to the second voltage value V2, the duty P7 calculated from the corrected three-phase voltage command P6 becomes smaller than 0%.

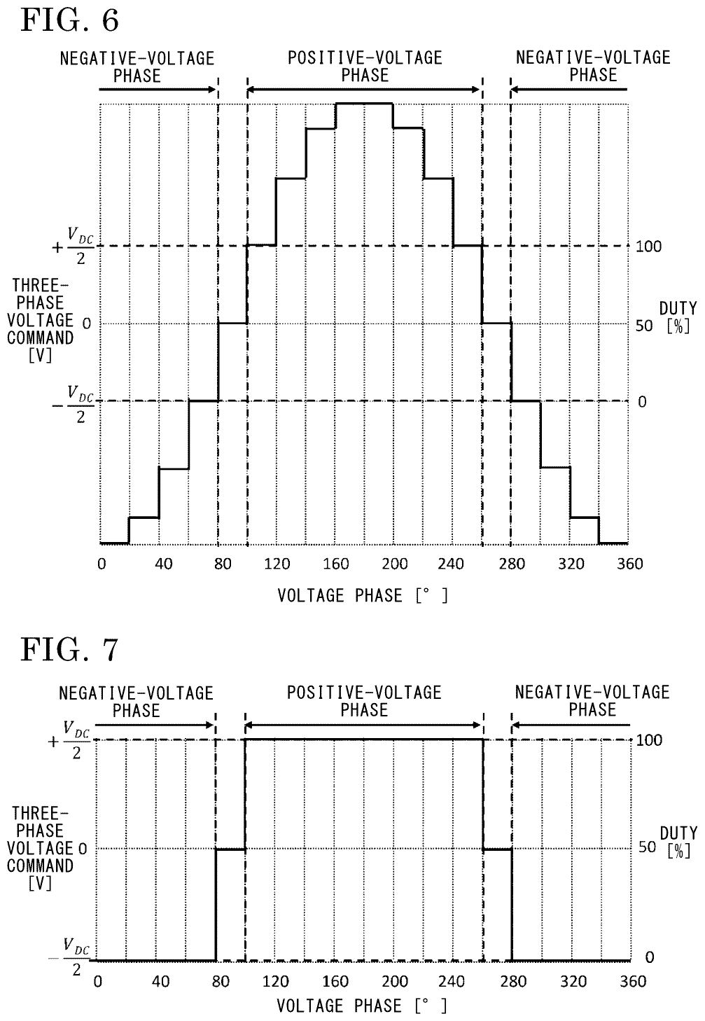

Another method for correcting the duty to 100% or greater or to 0% or smaller will be described. FIG. 6 shows an example of correction of the three-phase voltage command according to embodiment 1, and illustrates correction of making the duty be 100% or greater or be 0% or smaller. In FIG. 6, a “zero-voltage phase” is not shown. The “three-phase voltage command” and the “duty” in FIG. 6 represent those for any of u phase, v phase, and w phase. In the example shown in FIG. 6, the three-phase voltage command P3 is multiplied by a gain, to correct the duty to 100% or greater or to 0% or smaller. As a method for correcting the duty P7 to 100% or greater in a case of “positive-voltage phase”, for each phase of the three-phase voltage command P3, a ratio of the minimum value in a case of “positive-voltage phase” and Vref_MAX (=+Vdc/2) is calculated, and a gain (corresponding to a first gain) having a value not smaller than the ratio is set. By setting the gain so that even the minimum value in a case of “positive-voltage phase” becomes a value not smaller than Vref_MAX, a value after multiplication by the gain becomes Vref_MAX or greater in the entire phase range in a case of “positive-voltage phase”, and the duty also becomes 100% or greater.

As a method for correcting the duty P7 to 0% or smaller in a case of “negative-voltage phase”, for each phase of the three-phase voltage command P3, a ratio of the maximum value (which is negative and therefore the absolute value thereof is minimum) in a case of “negative-voltage phase” and Vref_MIN (=−Vdc/2) is calculated, and a gain (corresponding to a second gain) having a value not smaller than the ratio is set. By setting the gain so that even the maximum value in a case of “negative-voltage phase” becomes a value not greater than Vref_MIN (the value is negative and therefore the absolute value thereof is not smaller than Vref_MIN), a value after multiplication by the gain becomes Vref_MIN or smaller in the entire phase range in a case of “negative-voltage phase”, and the duty also becomes 0% or smaller.

Since the DC voltage value Vdc can be set in advance, Vref_MAX and Vref_MIN can also be set in advance. Therefore, the minimum value in a case of “positive-voltage phase” and the maximum value in a case of “negative-voltage phase” are acquired in advance, and the first gain and the second gain are set in advance.

As a method for correcting the duty to 100% or greater, for example, there is a method of correcting the three-phase voltage command P3 on the basis of the DC voltage value Vdc as shown in FIG. 7. By setting the corrected three-phase voltage command P6 in accordance with the DC voltage value Vdc as shown in Formulae (9) and (10), the duty can be made to be 100% or greater or be 0% or smaller.

The carrier wave generation unit 16 receives the rotation position signal SR from 901 and the voltage phase P2 from the two-phase/three-phase conversion unit 11. The carrier wave generation unit 16 acquires the rotation position of the rotating machine 900 from the rotation position signal SR, and acquires an electric angle frequency which is a frequency of the electric angle Ge, from the rotation position of the rotating machine 900. The carrier wave generation unit 16 generates the carrier wave P8 having a frequency that is an odd multiple of the electric angle frequency. The carrier wave generation unit 16 outputs the generated carrier wave P8 to the PWM control unit 17.

The PWM control unit 17 receives the duty P7 from the three-phase voltage command normalization unit 15 and the carrier wave P8 from the carrier wave generation unit 16. The PWM control unit 17 compares the magnitude of the duty P7 which is normalized voltage commands for three phases, with the magnitude of the carrier wave P8, and generates the switching pattern P9 on the basis of the comparison result. The PWM control unit 17 outputs the switching pattern P9 to the inverter 81. In the inverter 81, the switching elements are switched ON and OFF in accordance with the switching pattern P9, whereby the DC power DC from the power supply unit 82 is converted to desired AC voltage.

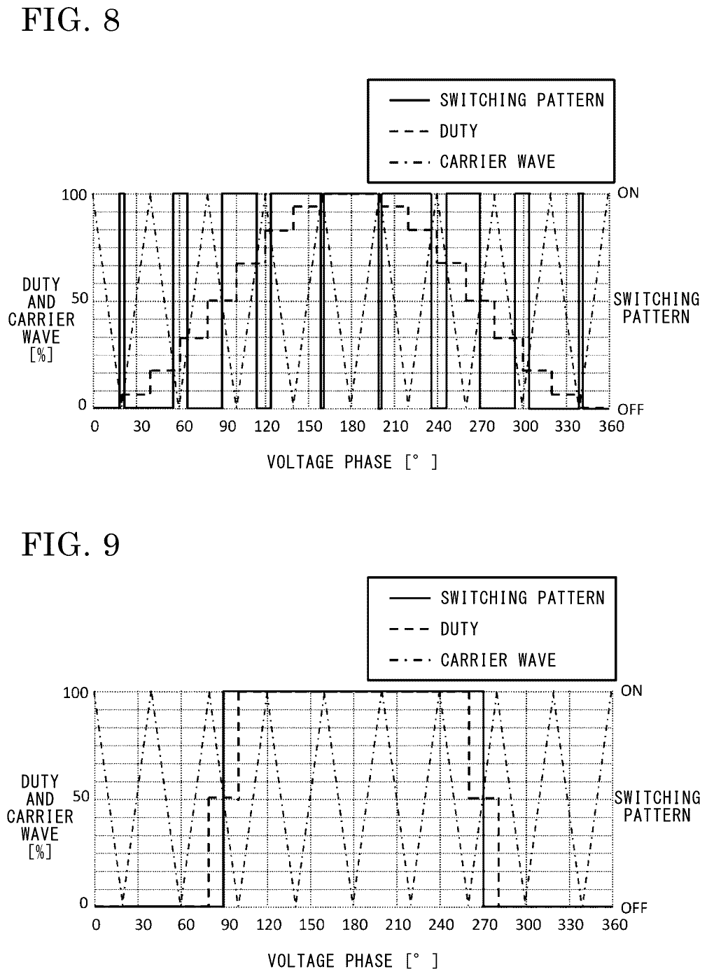

FIG. 8 shows an example of the relationship among the duty, the carrier wave, and the switching pattern according to embodiment 1, in a case where the duty is calculated without correction of the three-phase voltage command. In FIG. 8, the switching pattern is indicated by a solid line, and the duty is indicated by a broken line. The carrier wave is indicated by a dotted-dashed line. The “duty”, the “carrier wave”, and the “switching pattern” in FIG. 8 represent those for any of u phase, v phase, and w phase. As is found from FIG. 8, the duty P7 calculated in a case where the three-phase voltage command (three-phase voltage command P3) not corrected by the three-phase voltage command correction unit 14 is normalized, has a sinewave shape. In the example shown in FIG. 8, the frequency (carrier wave frequency) of the carrier wave P8 is nine times the electric angle frequency of the rotating machine 900 (equal to the frequency of the three-phase voltage command). In this case, the duty P7 is calculated in half the cycle of the carrier wave P8. Also in FIG. 8, it is found that calculation for updating the duty P7 is performed at timings of a crest and a trough of the carrier wave P8.

The PWM control unit 17 compares the duty P7 with the carrier wave P8. Then, if the duty P7 is greater than the carrier wave P8, the PWM control unit 17 sets the switching pattern P9 at ON, and if the duty P7 is smaller than the carrier wave P8, the PWM control unit 17 sets the switching pattern P9 at OFF. In a case where the duty P7 has a sinewave shape as shown in the example in FIG. 8, the switching pattern P9 obtained through comparison between the duty P7 and the carrier wave P8 as described above has the same number of times of ON-OFF repetition as what multiple the carrier wave frequency is relative to the electric angle frequency. In the example shown in FIG. 8, since the carrier wave frequency is nine times the electric angle frequency, the switching pattern P9 has nine times of ON-OFF repetition in one cycle of electric angle.

FIG. 9 shows an example of the relationship among the duty, the carrier wave, and the switching pattern according to embodiment 1, in a case where the duty is calculated with the three-phase voltage command corrected. In the example shown in FIG. 9, the three-phase voltage command correction amount P5 in correction at a “zero-voltage phase” is zero. As is found from FIG. 9, the duty P7 calculated in a case where the three-phase voltage command (corrected three-phase voltage command P6) corrected by the three-phase voltage command correction unit 14 is normalized, has a value corresponding to each of a “positive-voltage phase”, a “zero-voltage phase”, and a “negative-voltage phase”, and thus becomes 100% or greater, 50%, or 0% or smaller, depending on the voltage phase. Here, in comparison with the carrier wave P8, there is no problem if 100% or greater is regarded as 100% and 0% or smaller is regarded as 0%. As shown in FIG. 9, the switching pattern P9 obtained by comparing the duty P7 calculated from the corrected three-phase voltage command P6 with the carrier wave P8 has a rectangular wave shape, and thus rectangular wave control is realized. The number of times of ON-OFF repetition in the switching pattern P9 in one cycle of electric angle is only one.

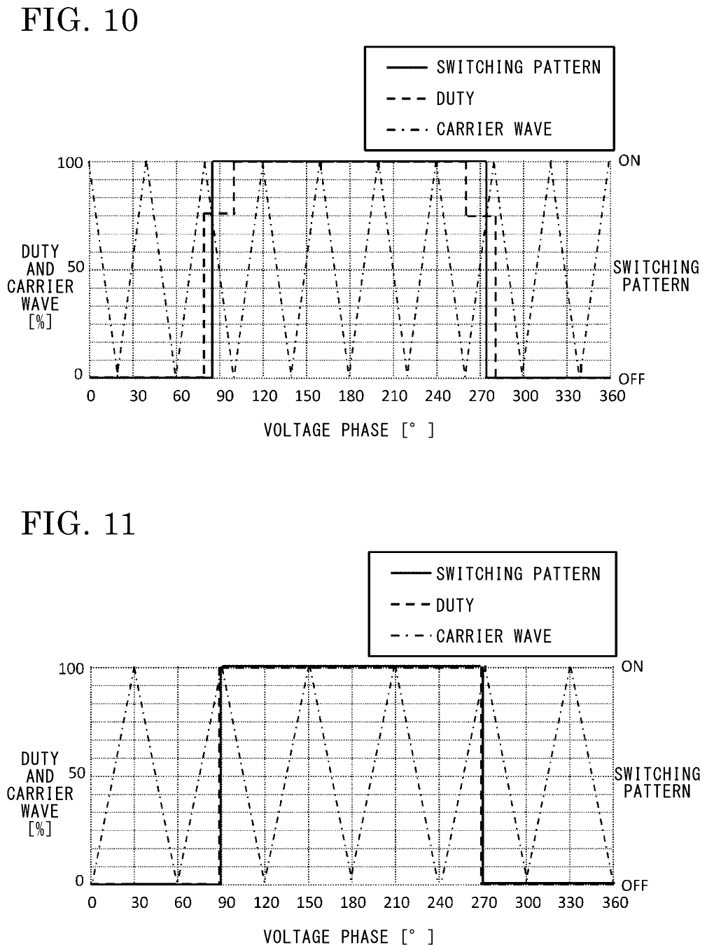

FIG. 10 shows an example of the relationship among the duty, the carrier wave, and the switching pattern according to embodiment 1, in a case where the duty is calculated with the three-phase voltage command corrected and correction is performed to adjust ON/OFF switchover timings of the rectangular-wave-shaped switching pattern. Specifically, at a “zero-voltage phase”, correction is performed by the three-phase voltage command correction amount (in a case of u phase, the u-phase voltage command correction amount Vuo shown in Formula (6)) so that the duty P7 changes from 50% to 75%. As shown in the example in FIG. 9, in a case where the duty P7 at a “zero-voltage phase” is 50%, a voltage phase at a timing when the switching pattern P9 switches from OFF to ON is 90°, and a voltage phase at a timing when the switching pattern P9 switches from ON to OFF is 270°. As shown in the example in FIG. 10, in a case where the duty P7 at a “zero-voltage phase” is 75%, a voltage phase at a timing when the switching pattern P9 switches from OFF to ON is 85°, and a voltage phase at a timing when the switching pattern P9 switches from ON to OFF is 275°. In the example in FIG. 9, an ON period of the switching pattern P9 is 180° (90° to 270°), whereas in the example in FIG. 10, an ON period of the switching pattern P9 is 190° (85° to 275°) and thus is longer by 10°. By adjusting the ON period of the switching pattern P9 by the three-phase voltage command correction amount as shown in Formula (6), offset components of the three-phase currents are reduced.

As described above, by adjusting the three-phase voltage command correction amount (u-phase voltage command correction amount Vuo, v-phase voltage command correction amount Vvo, and w-phase voltage command correction amount Vwo) at a “zero-voltage phase”, ON/OFF switchover timings of the switching pattern P9 can be adjusted, whereby desired three-phase voltages can be realized. In addition, such adjustment of the three-phase voltage command correction amount does not require fine division of the calculation cycle and therefore does not cause increase in the calculation amount.

In a case of generating the switching pattern P9 through comparison between the carrier wave P8 and the duty P7 in PWM control, it is necessary to synchronize the phases of the carrier wave P8 and the duty P7 with each other, in order to generate a desired switching pattern P9. Therefore, the PWM control unit 17 corrects the phase of the carrier wave P8 as necessary, so as to eliminate a phase shift between the carrier wave P8 and the duty P7. At this time, a correction amount for the phase of the carrier wave P8 is calculated on the basis of the amount of a phase shift from the carrier wave P8 synchronized with the duty P7. By synchronizing the phases of the carrier wave P8 and the duty P7, shift of ON/OFF switchover timings of the switching pattern P9 is prevented and thus a desired switching pattern P9 is obtained, whereby desired three-phase voltages can be applied to the inverter 81.

In a case where the rotating machine 900 is a three-phase rotating machine, it is preferable that a value obtained by dividing the carrier wave frequency by the electric angle frequency is an odd multiple of 3. That is, it is preferable that a driving pattern such as a synchronous 3-pulse pattern, a synchronous 9-pulse pattern, or a synchronous 15-pulse pattern is applied. In this case, rectangular wave voltages for three phases applied to the rotating machine 900 become positive-negative symmetric, so that the rotating machine 900 can be controlled more stably.

Here, the carrier wave frequency needs to be an odd multiple of the electric angle frequency. For comparison, FIG. 11 shows the relationship among the duty, the carrier wave, and the switching pattern, in a case where rectangular wave control is performed with the carrier wave frequency set to be an even multiple of the electric angle frequency. As is found from FIG. 11, in a case where the switching pattern P9 is made into a rectangular wave with the carrier wave frequency set to be an even multiple (in the example shown in FIG. 11, six times) of the electric angle frequency, there is no zero-voltage phase in the duty P7. Therefore, in embodiment 1, the carrier wave frequency needs to be an odd multiple of the electric angle frequency.

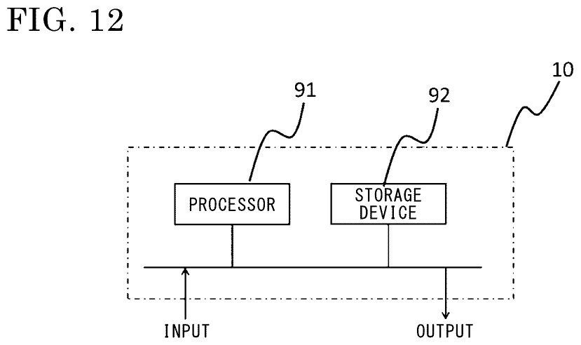

Next, a hardware configuration for implementing the inverter control unit 10 will be described. FIG. 12 shows an example of a hardware configuration of the inverter control unit according to embodiment 1. As shown in FIG. 12, the inverter control unit 10 includes a processing circuit mainly composed of a processor 91 and a storage device 92, and the function units shown in FIG. 1 are implemented by the processing circuit. The processor 91 is formed by, for example, a central processing unit (CPU), a digital signal processor (DSP), an application specific integrated circuit (ASIC), a field programmable gate array (FPGA), any logic circuit, any signal processing circuit, or the like. The storage device 92 includes a memory (not shown) as a main storage device, and an auxiliary storage device (not shown). The memory is formed by a volatile storage device such as a random access memory, and the auxiliary storage device is formed by a nonvolatile storage device such as a flash memory, a hard disk, or the like. The auxiliary storage device stores a predetermined program to be executed by the processor 91, and the processor 91 reads and executes the program as appropriate, to perform various calculation processes. At this time, the predetermined program is temporarily stored into the memory from the auxiliary storage device, and the processor 91 reads the program from the memory. Processing by each processing unit in the inverter control unit 10 is implemented by the processor 91 executing the predetermined program as described above.

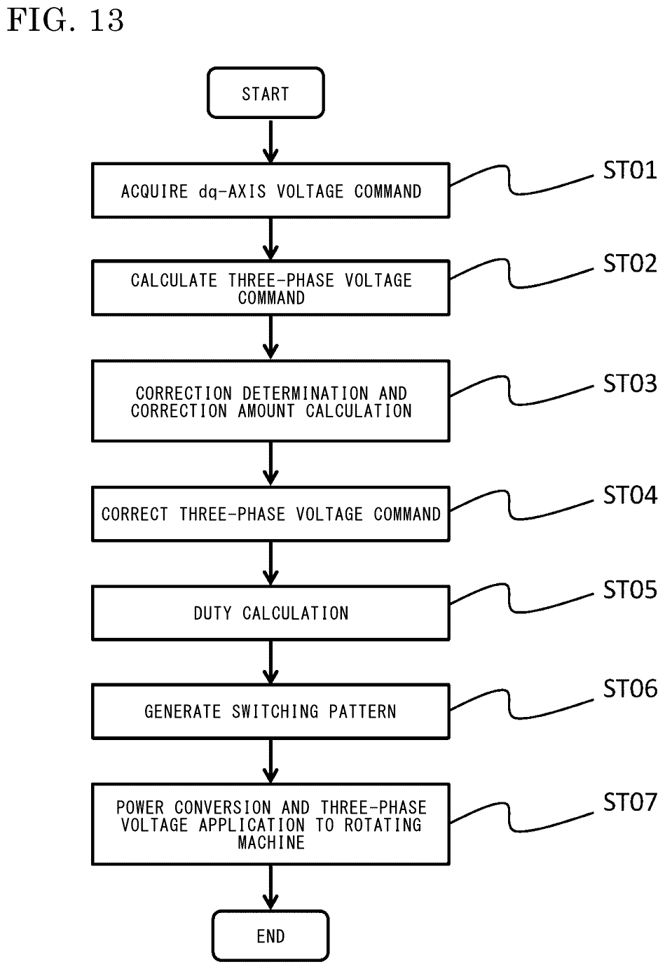

Next, operation will be described. FIG. 13 is a flowchart showing operation of the rotating machine control device according to embodiment 1. First, the dq-axis voltage command P1 is acquired by, for example, being received from an external host controller (step ST01, voltage command acquisition step). In the voltage command acquisition step, the rotation position signal indicating the rotation position of the rotating machine 900 is also received.

Next, the three-phase voltage command P3 and the voltage phase P2 thereof are calculated from the dq-axis voltage command P1 and the rotating machine 900 (step ST02, three-phase voltage command calculation step).

Next, correction determination based on a voltage phase is performed for each phase (u phase, v phase, and w phase). In addition, for each phase, the three-phase voltage command correction amount is calculated (step ST03, correction determination step and correction amount calculation step). In the correction determination step, which the voltage phase is among a “zero-voltage phase”, a “positive-voltage phase”, and a “negative-voltage phase”, is determined, thus obtaining the correction determination result P4. As described above, in embodiment 1, determination for the voltage phase corresponds to correction determination. In the correction amount calculation step, a correction amount for the three-phase voltage command at a “zero-voltage phase”, i.e., the u-phase voltage command correction amount Vuo shown in Formula (6), is calculated so as to reduce an offset component of three-phase current at a “zero-voltage phase”. Calculation is performed in the same manner also for the v-phase voltage command correction amount Vvo and the w-phase voltage command correction amount Vwo.

Next, on the basis of the correction determination result P4, the three-phase voltage command P3 is corrected, thus obtaining the corrected three-phase voltage command P6 (step ST04, three-phase voltage command correction step). As described above, the correction method differs depending on which the voltage phase is determined to be among a “zero-voltage phase”, a “positive-voltage phase”, and a “negative-voltage phase”.

Next, the corrected three-phase voltage command P6 for each phase is normalized, thus obtaining the duty P7 (step ST05, normalization step).

Next, the duty P7 is compared with the carrier wave P8, thus obtaining the switching pattern P9 (step ST06, switching pattern generation step).

Next, the inverter 81 converts the DC power DC to AC power, thus obtaining three-phase voltages, and the three-phase voltages are applied to the rotating machine 900 (step ST07, power conversion step and three-phase voltage application step). In the power conversion step, the switching elements of the inverter 81 are driven by the switching pattern P9, to obtain desired three-phase voltages. In the three-phase voltage application step, the three-phase voltages are applied to three-phase windings provided to the stator of the rotating machine 900, thereby driving the rotating machine 900. In addition, three-phase currents flowing between the inverter 81 and the rotating machine 900 are detected and the rotation position of the rotating machine 900 is detected.

In embodiment 1, a voltage command from the outside is used as the dq-axis voltage command P1, and the two-phase/three-phase conversion unit 11 converts the dq-axis voltage command P1 to the three-phase voltage command P3. However, if the voltage command from the outside is a three-phase voltage command, the two-phase/three-phase conversion unit 11 may be omitted. In this case, the three-phase voltage command from the outside is received by the three-phase voltage command correction determination unit 12 and the three-phase voltage command correction unit 14. In addition, the voltage phase of the voltage command from the outside is received by the three-phase voltage command correction determination unit 12 and the carrier wave generation unit 16.

The relationship between the dq-axis voltage phase θ1, and the u-phase voltage phase θ2u, the v-phase voltage phase θ2v, and the w-phase voltage phase θ2w which are voltage phases for respective phases of the voltage phase P2, is as shown by Formulae (3), (4), and (5), and when the electric angle θe is known, the dq-axis voltage phase θ1 can be converted to each of the u-phase voltage phase θ2u, the v-phase voltage phase θ2v, and the w-phase voltage phase θ2w, and reverse conversion is also possible. Therefore, the “three-phase voltage command” and the “voltage phase” in FIG. 3 can be replaced with the dq-axis voltage command P1 and the dq-axis voltage phase θ1. Accordingly, it is conceivable that correction determination based on a “zero-voltage phase”, a “positive-voltage phase”, and a “negative-voltage phase” is performed for the dq-axis voltage phase θ1, correction by the three-phase voltage command correction unit 14 described above is performed on the dq-axis voltage command P1, and then the corrected dq-axis voltage command P1 is subjected to two-phase/three-phase conversion, thus obtaining the corrected three-phase voltage command P6.

In embodiment 1, the three-phase voltage command P3 is corrected before normalization by the three-phase voltage command normalization unit 15. However, determination for a “zero-voltage phase”, a “positive-voltage phase”, and a “negative-voltage phase” and the correction determination result P4 based thereon, do not change even for the voltage phase after normalization. Therefore, if the DC voltage value Vdc needed for normalization is known, it is conceivable that the three-phase voltage command P3 before correction is normalized, to calculate a pre-correction duty in which correction has not been reflected, and then correction is performed.

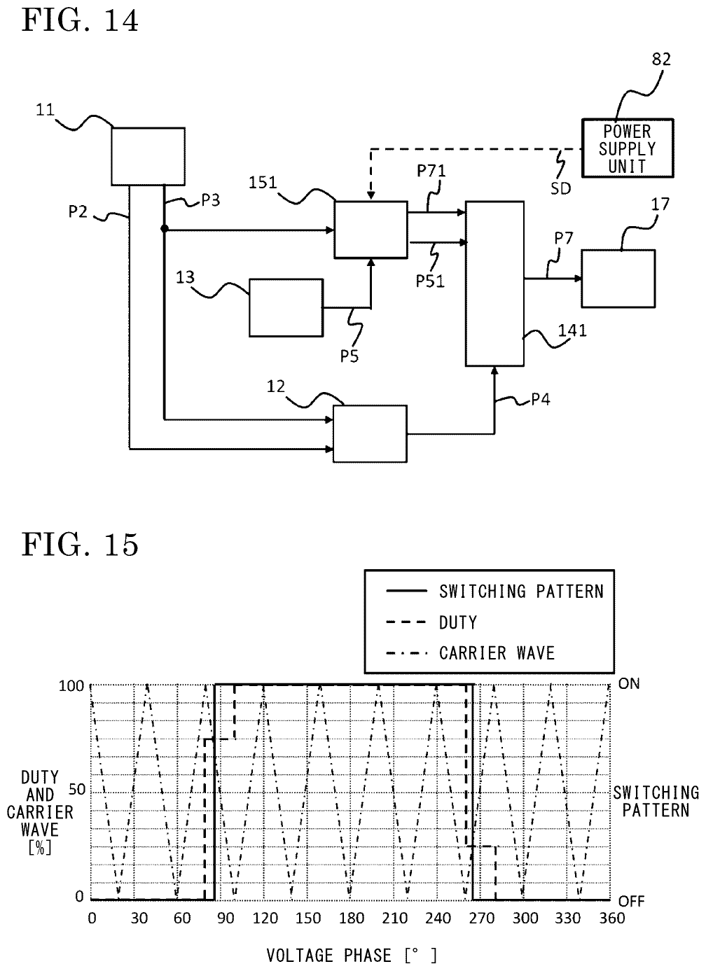

FIG. 14 illustrates an example in which the three-phase voltage command before correction is normalized to calculate a pre-correction duty and then correction is performed on the pre-correction duty. Among all the components shown in FIG. 1, only components needed for description are shown. A three-phase voltage command normalization unit 151 receives the three-phase voltage command P3 from the two-phase/three-phase conversion unit 11 and the three-phase voltage command correction amount P5 from the three-phase voltage command correction amount calculation unit 13. In addition, the three-phase voltage command normalization unit 151 receives the DC voltage signal SD from the power supply unit 82. The three-phase voltage command normalization unit 151 normalizes the three-phase voltage command P3 before correction, to calculate a pre-correction duty P71 which is a duty in which correction has not been reflected. Normalization of the three-phase voltage command P3 is the same as in the three-phase voltage command normalization unit 15. In addition, the three-phase voltage command normalization unit 151 normalizes the three-phase voltage command correction amount P5, to calculate a duty correction amount P51. The duty correction amount P51 includes a u-phase duty correction amount Duo, a v-phase duty correction amount Dvo, and a w-phase duty correction amount Dwo. The three-phase voltage command normalization unit 151 outputs the pre-correction duty P71 and the duty correction amount P51 to the duty correction unit 141.

Calculation of the duty correction amount P51 will be described for u phase as an example. The u-phase duty correction amount Duo needed for correction at a “zero-voltage phase” is obtained by replacing the u-phase duty Du and the u-phase voltage command Vu in Formula (8) with the u-phase duty correction amount Duo and the u-phase voltage command correction amount Vuo, and thus is shown by the following Formula (11), for example.

$$Duo = ( Vuo / Vdc + 0.5 ) \times 100 ( \% ) \qquad ( 11 )$$

A duty correction unit 141 receives the pre-correction duty P71 and the duty correction amount P51 from the three-phase voltage command normalization unit 151, and the correction determination result P4 from the three-phase voltage command correction determination unit 12.

The duty correction unit 141 corrects the pre-correction duty P71 on the basis of the correction determination result P4. As an example, in a case of u phase, at a “zero-voltage phase”, the u-phase duty correction amount Duo is added (or subtracted, depending on the u-phase duty correction amount Duo) to the u-phase duty Du in which correction has not been reflected, to perform correction of offsetting the pre-correction duty P71 in the amplitude direction. At a “positive-voltage phase”, the u-phase duty Du in which correction has not been reflected is corrected to 100% or greater. At a “negative-voltage phase”, the u-phase duty Du in which correction has not been reflected is corrected to 0% or smaller. The same applies to the v-phase duty Dv and the w-phase duty Dw.

By performing the above correction on the pre-correction duty P71, the duty correction unit 141 obtains the same result as in the case of normalizing the corrected three-phase voltage command P6. That is, the duty P7 is calculated. The duty correction unit 141 outputs the duty P7 to the PWM control unit 17. The subsequent operation is the same as in the example in FIG. 1.

The correction determination result P4 does not change due to normalization by the three-phase voltage command normalization unit 151. That is, the voltage phase P2 that is determined to be a “zero-voltage phase” before normalization is also determined to be a “zero-voltage phase” after normalization. This is because, as is found from FIG. 4 and the like, if the three-phase voltage command before normalization is 0 V, the duty after normalization always becomes a duty of 50%. That is, the “zero-voltage phase which is a voltage phase when the three-phase voltage command is determined to be zero” is the same as the “zero-voltage phase which is a voltage phase when the duty is determined to be 50%”. The same applies to the “positive-voltage phase” and the “negative-voltage phase”. Therefore, although FIG. 14 shows the example in which correction determination is performed on the basis of the three-phase voltage command P3 and the voltage phase P2, correction determination may be performed on the basis of the pre-correction duty P71 and the voltage phase P2. In this case, a voltage phase when the value of the pre-correction duty P71 is 50% is determined to be a “zero-voltage phase”, a voltage phase when the value of the pre-correction duty P71 is greater than 50% is determined to be a “positive-voltage phase”, and a voltage phase when the value of the pre-correction duty P71 is smaller than 50% is determined to be a “negative-voltage phase”.

In embodiment 1, it suffices that the duty P7 in which correction has been reflected is compared with the carrier wave P8, to obtain the switching pattern P9. As described above, in order to finally calculate the duty P7, the three-phase voltage command may be corrected first, or the three-phase voltage command before correction may be normalized and then the duty in which correction has not been reflected may be corrected. Irrespective of whether correction is performed before normalization or after normalization, the duty finally obtained, i.e., the duty P7 to be compared with the carrier wave P8, is the corrected one.

According to embodiment 1, it is possible to adjust ON/OFF switchover timings of rectangular wave voltage while preventing increase in the calculation amount. More specifically, an inverter control unit of the rotating machine control device includes: a two-phase/three-phase conversion unit which, on the basis of a rotation position of a rotating machine, converts a dq-axis voltage command to a three-phase voltage command and calculates a voltage phase of the three-phase voltage command; a three-phase voltage command correction determination unit which determines a correction method for the three-phase voltage command and outputs a correction determination result; a three-phase voltage command correction unit which corrects the three-phase voltage command on the basis of the correction determination result, to calculate a corrected three-phase voltage command; a three-phase voltage command correction amount calculation unit which calculates a three-phase voltage command correction amount which is a correction amount for the three-phase voltage command; a three-phase voltage command normalization unit which normalizes the corrected three-phase voltage command, to calculate a duty; a carrier wave generation unit which generates a carrier wave having a frequency that is an odd multiple of an electric angle frequency of the rotating machine; and a switching pattern generation unit which generates a switching pattern by comparing the duty with the carrier wave. The three-phase voltage command correction determination unit determines the correction method on the basis of the voltage phase of the three-phase voltage command, and determines the correction method in accordance with which the voltage phase is among a “zero-voltage phase” which is the voltage phase when the three-phase voltage command is determined to be zero, a “positive-voltage phase” which is the voltage phase when the three-phase voltage command is determined to be positive, and a “negative-voltage phase” which is the voltage phase when the three-phase voltage command is determined to be negative. In a case where the voltage phase is determined to be the “zero-voltage phase”, the three-phase voltage command correction unit performs correction of adding or subtracting the three-phase voltage command correction amount to or from the three-phase voltage command. In a case where the voltage phase is determined to be the “positive-voltage phase”, the three-phase voltage command correction unit corrects the three-phase voltage command to such a value that the duty becomes 100% or greater. In a case where the voltage phase is determined to be the “negative-voltage phase”, the three-phase voltage command correction unit corrects the three-phase voltage command to such a value that the duty becomes 0% or smaller.

Adjustment of ON/OFF switchover timings of rectangular wave voltage is performed through adjustment of ON/OFF switchover timings of a switching pattern. Here, in embodiment 1, in a case where the voltage phase is determined to be the “zero-voltage phase”, the three-phase voltage command is offset (addition or subtraction) by the three-phase voltage command correction amount, thereby adjusting ON/OFF switchover timings of the switching pattern. As described above, in a case where ON/OFF switchover timings of the switching pattern are adjusted by offset of the three-phase voltage command at the “zero-voltage phase”, it is not necessary to increase the calculation amount per one cycle of electric angle, unlike the conventional technology described in Patent Document 1. Thus, it is possible to adjust ON/OFF switchover timings of rectangular wave voltage while preventing increase in the calculation amount. In addition, since the correction method is determined in accordance with the phase of the three-phase voltage command, determination of the correction method is easy and increase in the calculation amount due to determination of the correction method is small. Therefore, high calculation processing performance is not required and desired rectangular wave control can be realized even by an inexpensive processing device.

In a case where the voltage phase is determined to be the “positive-voltage phase”, the three-phase voltage command is corrected to such a value that the duty becomes 100% or greater, and in a case where the voltage phase is determined to be the “negative-voltage phase”, the three-phase voltage command is corrected to such a value that the duty becomes 0% or smaller. Thus, the switching pattern is made into a rectangular wave shape, so that rectangular wave control is realized.

The frequency of the carrier wave to be compared with the duty is an odd multiple of the electric angle frequency of the rotating machine, i.e., the frequency of the voltage phase of the three-phase voltage command. Therefore, presence of the voltage phase that becomes the “zero-voltage phase” is ensured.

An output current detection unit is provided for detecting three-phase current flowing between the inverter and the rotating machine, and the three-phase voltage command correction amount calculation unit calculates the three-phase voltage command correction amount so as to reduce an offset component of the three-phase current, on the basis of the three-phase current. Thus, through correction of the three-phase voltage command, an offset component of the three-phase current can be reduced.

The three-phase voltage command correction amount calculation unit calculates the three-phase voltage command correction amount through such feedback control that makes an integral value of the three-phase current close to zero. Thus, it is possible to more assuredly reduce an offset component of the three-phase current.

A voltage detection unit is provided for detecting a DC voltage value of DC power supplied to an inverter. In a case where the voltage phase is determined to be the “positive-voltage phase”, the three-phase voltage command correction unit corrects the three-phase voltage command to a first voltage value determined on the basis of the DC voltage value, to make the duty be 100% or greater, and in a case where the voltage phase is determined to be the “negative-voltage phase”, the three-phase voltage command correction unit corrects the three-phase voltage command to a second voltage value determined on the basis of the DC voltage value, to make the duty be 0% or smaller. Thus, even if the DC voltage value of the power supply unit is changed, rectangular wave control is realized.

In a case where the voltage phase is determined to be the positive-voltage phase, the three-phase voltage command correction unit multiplies the three-phase voltage command by a predetermined first gain, to make the duty be 100% or greater, and in a case where the voltage phase is determined to be the negative-voltage phase, the three-phase voltage command correction unit multiplies the three-phase voltage command by a predetermined second gain, to make the duty be 0% or smaller. The first gain and the second gain are set on the basis of the DC voltage value. Thus, even if the DC voltage value of the power supply unit is changed, rectangular wave control is realized.

A value obtained by dividing the frequency of the carrier wave by the electric angle frequency is an odd multiple of 3. Thus, in a case where the rotating machine is a three-phase rotating machine, rectangular wave voltages for three phases applied to the rotating machine become positive-negative symmetric, so that the rotating machine can be controlled more stably.

Next, modification 1 of embodiment 1 will be described with reference to FIG. 15. In embodiment 1, the pulse width of rectangular wave voltage, i.e., the ON period of the switching pattern P9, is adjusted to reduce offset components of three-phase currents. In modification 1 of embodiment 1, the phase of rectangular wave voltage is adjusted to reduce offset components of three-phase currents. A phase correction amount to be used for adjusting the phase of rectangular wave voltage is calculated on the basis of at least one state quantity such as the torque of the rotating machine 900, the rotation speed thereof, three-phase current flowing through a winding of the rotating machine 900, and a modulation factor. As the phase correction amount, a value calculated in real time on the basis of the above state quantity may be used, or a fixed value calculated in advance on the basis of the above state quantity may be used. Here, an example in which the phase correction amount is calculated through feedback control of torque of the rotating machine 900 will be described. As the torque of the rotating machine 900, a value detected by a sensor or the like may be used or an estimated value may be used. The estimated value may be obtained using a current value of three-phase current flowing through a winding of the rotating machine 900 or a voltage value of three-phase voltage applied to a winding of the rotating machine 900. The phase correction amount is the same value among u phase, v phase, and w phase.

In modification 1 of embodiment 1, the three-phase voltage command correction amount at a “zero-voltage phase” is set to be different between a case where the three-phase voltage command P3 switches from negative to positive and a case where the three-phase voltage command P3 switches from positive to negative. As shown in FIG. 4, there are two “zero-voltage phases”, i.e., a case of switching from a “negative-voltage phase” to a “positive-voltage phase” (in the example shown in FIG. 4, 80° to 100°) and a case of switching from a “positive-voltage phase” to a “negative-voltage phase” (in the example shown in FIG. 4, 260° to 280°). In modification 1 of embodiment 1, the former case is referred to as a “first zero-voltage phase”, the latter case is referred to as a “second zero-voltage phase”, and the three-phase voltage command correction amount is set to be different between a “first zero-voltage phase” and a “second zero-voltage phase”.

FIG. 15 shows an example of the relationship among the duty, the carrier wave, and the switching pattern according to modification 1 of embodiment 1. In the example shown in FIG. 15, the three-phase voltage command correction amount used for correction at the “first zero-voltage phase” and the three-phase voltage command correction amount used for correction at the “second zero-voltage phase” have the same absolute value of 25% and opposite signs of positive and negative. Thus, the duty P7 at the “first zero-voltage phase” becomes 75%, and the duty P7 at the “second zero-voltage phase” becomes 25%. As a result, a timing when the switching pattern P9 switches from OFF to ON is corrected from 90° to 85°, and a timing when the switching pattern P9 switches from OFF to ON is corrected from 270° to 265°. The ON period remains 180° without change, before and after correction. In this case, the phase correction amount is 5°, where a direction in which the phase proceeds is defined as positive. Thus, by setting the three-phase voltage command correction amounts at the “first zero-voltage phase” and the “second zero-voltage phase” so as to have the same absolute value and opposite signs of positive and negative, it is possible to adjust the phase of the switching pattern P9 while keeping the ON period of the switching pattern P9 constant. That is, by adjustment of the three-phase voltage command correction amount, it is possible to perform both of adjustment of the ON period of the switching pattern P9 and adjustment of the phase thereof.

Next, modification 2 of embodiment 1 will be described. In modification 2 of embodiment 1, a calculation method for the three-phase voltage command correction amount is different. Here, description will be given for the u-phase voltage command correction amount Vuo as an example, but the same applies to the v-phase voltage command correction amount Vvo and the w-phase voltage command correction amount Vwo. In modification 2 of embodiment 1, the u-phase voltage command correction amount Vuo is obtained by multiplying a fixed value set in advance as a correction amount for rectangular wave voltage by a proportional gain. Here, a “fixed value set in advance as a correction amount for rectangular wave voltage” is a desired value to correct rectangular wave voltage applied to a winding of the rotating machine 900. Also in modification 2 of embodiment 1, correction of adding or subtracting the u-phase voltage command correction amount Vuo to or from the u-phase voltage command Vu is performed in correction at a “zero-voltage phase”. Here, correction at a “zero-voltage phase” is performed only twice per one cycle of electric angle. Thus, considering a correction amount per one cycle of electric angle, an actual correction amount tends to be smaller than an originally desired correction amount. Therefore, a value obtained by multiplying the originally desired correction amount by the proportional gain is used as the u-phase voltage command correction amount Vuo, so that the correction amount is set to be greater than the originally desired correction amount, thereby obtaining a sufficient correction amount.

Setting of the proportional gain will be described. Here, it is assumed that the carrier wave frequency is N times the electric angle frequency and calculation of the u-phase voltage command Vu is performed by a control method of updating the u-phase voltage command Vu in half the cycle of the carrier wave. In this case, the number of times of calculation of the u-phase voltage command Vu per one cycle of electric angle is 2×N. Thus, the u-phase voltage command correction amount Vuo is represented by the following Formula (12).

$$Vuo = ( 2 \times N ) / 2 \times Vuo\_ofs = N \times Vuo\_ofs \qquad ( 12 )$$

Here, Vuo_ofs is the “fixed value set in advance as a correction amount for rectangular wave voltage”, and is a desired value to correct rectangular wave voltage applied to a winding of the rotating machine 900.

As described above, the carrier wave frequency is N times the electric angle frequency and the u-phase voltage command Vu is updated in half the cycle of the carrier wave P8. Then, for example, as the value of N increases and the number of times of calculation of the u-phase voltage command Vu increases, the proportion of a “zero-voltage phase” in one cycle of electric angle decreases. Meanwhile, the u-phase voltage command correction amount Vuo is set as shown in Formula (12), and thus, when N is great, the proportional gain also becomes great and the u-phase voltage command correction amount Vuo also becomes great. That is, the phase voltage command correction amount Vuo is set so that reduction in the correction amount due to reduction in the proportion of a “zero-voltage phase” is cancelled out by increase in the correction amount due to increase in N.

As described above, in modification 2 of embodiment 1, the three-phase voltage command correction amount is calculated on the basis of the frequency of the carrier wave, so as to be greater than the original correction amount for rectangular wave voltage. Thus, the three-phase voltage command can be corrected more appropriately.

In a case where the rotating machine 900 is a three-phase rotating machine, it is preferable that N in Formula (12) is an odd multiple of 3. In this case, rectangular wave voltages for three phases applied to the rotating machine 900 become positive-negative symmetric, so that the rotating machine 900 can be controlled more stably.

### Embodiment 2

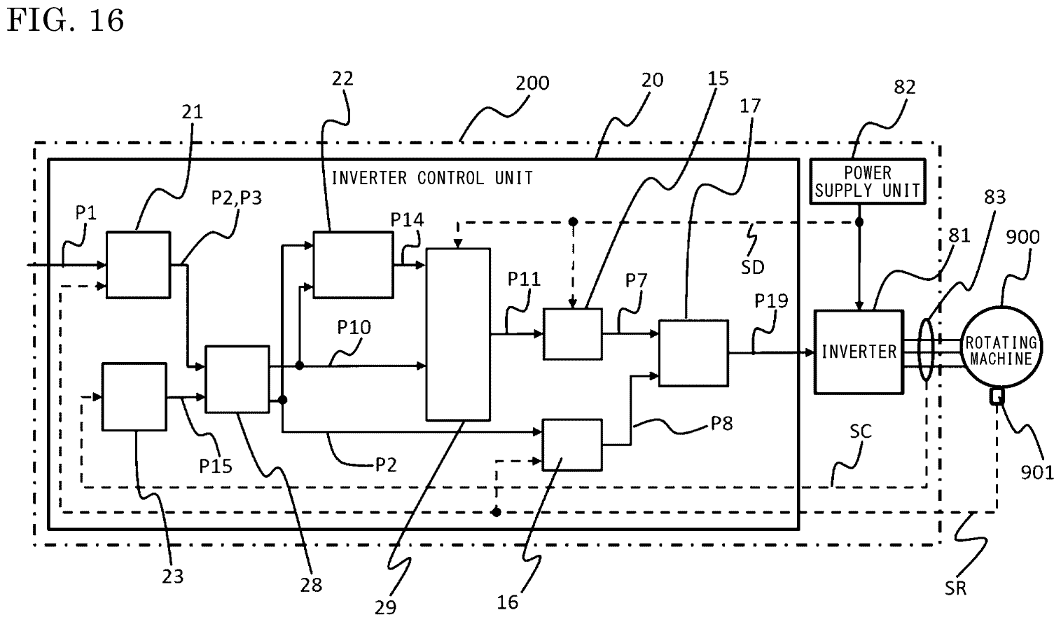

Embodiment 2 will be described with reference to FIG. 16 to FIG. 21. Components that are the same as or correspond to those in FIG. 1 to FIG. 15 are denoted by the same reference characters and the description thereof is omitted. As described below, embodiment 2 is different from embodiment 1 in that correction to the three-phase voltage command is divided into two stages. First correction is performed before the correction determination, and then second correction is performed on the basis of the correction determination result as in embodiment 1.

FIG. 16 is a configuration diagram showing a rotating machine control device according to embodiment 2. A rotating machine control device 200 is for controlling the rotating machine 900 in accordance with the dq-axis voltage command P1, and includes an inverter control unit 20, the inverter 81 which is controlled by the inverter control unit 20 and applies three-phase AC voltages to the rotating machine 900, and the power supply unit 82 which supplies DC power DC to the inverter 81. The output current detection unit 83 for detecting three-phase currents flowing between the inverter 81 and the rotating machine 900 is provided at the electric path connecting the inverter 81 and the rotating machine 900. The inverter 81, the power supply unit 82, and the output current detection unit 83 are the same as those in embodiment 1.

The inverter control unit 20 is for controlling the inverter 81 on the basis of the dq-axis voltage command, and includes a two-phase/three-phase conversion unit 21 which calculates the voltage phase P2 and the three-phase voltage command P3 on the basis of the dq-axis voltage command P1 and the rotation position signal SR, a three-phase voltage command correction amount calculation unit 23 which calculates a three-phase voltage command correction amount P15 on the basis of the three-phase current signal SC, a first three-phase voltage command correction unit 28 which calculates a first corrected three-phase voltage command P10 on the basis of the three-phase voltage command P3 and the three-phase voltage command correction amount P15, a first corrected three-phase voltage command correction determination unit 22 which performs correction determination for the first corrected three-phase voltage command P10 on the basis of the voltage phase P2 and the first corrected three-phase voltage command P10, and a second three-phase voltage command correction unit 29 which calculates a second corrected three-phase voltage command P11 on the basis of a correction determination result P14, the first corrected three-phase voltage command P10, and the DC voltage signal SD. In addition, the inverter control unit 20 includes the three-phase voltage command normalization unit 15 which normalizes the second corrected three-phase voltage command P11, to calculate the duty P7, the carrier wave generation unit 16 which generates the carrier wave P8 on the basis of the voltage phase P2 and the rotation position signal SR, and the PWM control unit 17 which generates the switching pattern P19 on the basis of the duty P7 and the carrier wave P8.

The two-phase/three-phase conversion unit 21 outputs the voltage phase P2 and the three-phase voltage command P3 to the first three-phase voltage command correction unit 28. The other matters are the same as in the two-phase/three-phase conversion unit 11 in embodiment 1.

The three-phase voltage command correction amount calculation unit 23 calculates the three-phase voltage command correction amount P15 which is a correction amount for adjusting a pulse width and a phase of rectangular wave voltage to be applied to the rotating machine 900, and outputs the calculated three-phase voltage command correction amount P15 to the first three-phase voltage command correction unit 28. As in the three-phase voltage command correction amount P5 of embodiment 1, the three-phase voltage command correction amount P15 includes the u-phase voltage command correction amount Vuo, the v-phase voltage command correction amount Vvo, and the w-phase voltage command correction amount Vwo which are correction amounts for voltage commands for respective phases, i.e., the u-phase voltage command Vu, the v-phase voltage command Vv, and the w-phase voltage command Vw. In addition, the three-phase voltage command correction amount calculation unit 23 receives the three-phase current signal SC from the output current detection unit 83, and calculates the three-phase voltage command correction amount P15 on the basis of the three-phase currents detected by the output current detection unit 83. Here, a calculation method for the three-phase voltage command correction amount P15 is partially different from the calculation method for the three-phase voltage command correction amount P5 in embodiment 1. Hereinafter, the details thereof will be described.

The three-phase voltage command correction amount P15 is also calculated so as to reduce offset components of three-phase currents, and therefore, for example, in a case of u phase, calculation is basically performed on the basis of Formula (6). Here, it is preferable that an upper limit value Vlim is set and the three-phase voltage command correction amount P15 is set in such a range that the absolute value of the three-phase voltage command correction amount P15 does not exceed the upper limit value Vlim. The upper limit value Vlim is a predetermined positive value. Hereinafter, the upper limit value Vlim may be simply referred to as Vlim. In a case where a result of Formula (6) satisfies −Vlim≤Vuo≤+Vlim, the u-phase voltage command correction amount Vuo calculated by Formula (6) is directly used. In a case of Vuo>+Vlim, it is preferable that Vuo is set at Vlim, and in a case of Vuo<−Vlim, it is preferable that Vuo is set at −Vlim. The same applies to the v-phase voltage command correction amount Vvo and the w-phase voltage command correction amount Vwo. The reason why it is preferable that the upper limit value Vlim is set for the three-phase voltage command correction amount P15 is that correction determination for determining a correction method for the first corrected three-phase voltage command P10 can be performed more appropriately. The details of correction determination for the first corrected three-phase voltage command P10 will be described later.

The first three-phase voltage command correction unit 28 receives the voltage phase P2 and the three-phase voltage command P3 from the two-phase/three-phase conversion unit 21. In addition, the first three-phase voltage command correction unit 28 receives the three-phase voltage command correction amount P15 from the three-phase voltage command correction amount calculation unit 23. The first three-phase voltage command correction unit 28 corrects the three-phase voltage command P3 on the basis of the three-phase voltage command correction amount P15, to calculate the first corrected three-phase voltage command P10. The first three-phase voltage command correction unit 28 outputs the first corrected three-phase voltage command P10 to the first corrected three-phase voltage command correction determination unit 22 and the second three-phase voltage command correction unit 29. In addition, the first three-phase voltage command correction unit 28 outputs the voltage phase P2 to the first corrected three-phase voltage command correction determination unit 22 and the carrier wave generation unit 16. The first corrected three-phase voltage command P10 also includes voltage commands for u phase, v phase, and w phase. These voltage commands are referred to as a first corrected u-phase voltage command Vu*1, a first corrected v-phase voltage command Vv*1, and a first corrected w-phase voltage command Vw*1.

Correction of the three-phase voltage command P3 by the first three-phase voltage command correction unit 28 is as follows. That is, irrespective of the voltage phase P2, the three-phase voltage command correction amount P15 is added to the three-phase voltage command P3. For example, in a case of u phase, Vu*1 becomes Vu+Vuo. The same applies to v phase and w phase. In other words, correction of adding or subtracting the three-phase voltage command correction amount, which would be performed in a case of “zero-voltage phase” in embodiment 1, is performed for the entire voltage phase range in one cycle of electric angle. The first corrected three-phase voltage command P10 calculated through this correction corresponds to a state in which the entirety of the three-phase voltage command P3 is offset in the amplitude direction by the three-phase voltage command correction amount P15. Meanwhile, as in embodiment 1, correction is performed so that offset components of three-phase currents become close to zero, and therefore, depending on the signs of the u-phase voltage command Vu and the u-phase voltage command correction amount Vuo, there is a case where the u-phase voltage command correction amount Vuo is subtracted from the u-phase voltage command Vu.

The first corrected three-phase voltage command correction determination unit 22 receives the voltage phase P2 and the first corrected three-phase voltage command P10 from the first three-phase voltage command correction unit 28. The first corrected three-phase voltage command correction determination unit 22 determines which the voltage phase P2 for each phase of the first corrected three-phase voltage command P10 is among a “zero-voltage phase”, a “positive-voltage phase”, and a “negative-voltage phase”, and on the basis of the determination result, performs correction determination for the first corrected three-phase voltage command P10. The three-phase voltage command correction determination unit 12 outputs the correction determination result P14 indicating the result of the correction determination, to the second three-phase voltage command correction unit 29.

As described above, the first corrected three-phase voltage command correction determination unit 22 performs correction determination on the basis of the voltage phase P2 as in embodiment 1, and corresponds to the correction determination unit. Meanwhile, the first corrected three-phase voltage command correction determination unit 22 performs correction determination on the basis of the first corrected three-phase voltage command P10 and the voltage phase P2. The first corrected three-phase voltage command P10 is in a state in which the three-phase voltage command P3 is offset by the three-phase voltage command correction amount P15 as described above, and therefore the voltage phase P2 that becomes a “zero-voltage phase” might be changed. Thus, the correction determination result P14 in embodiment 2 might be different from the correction determination result P4 in embodiment 1.

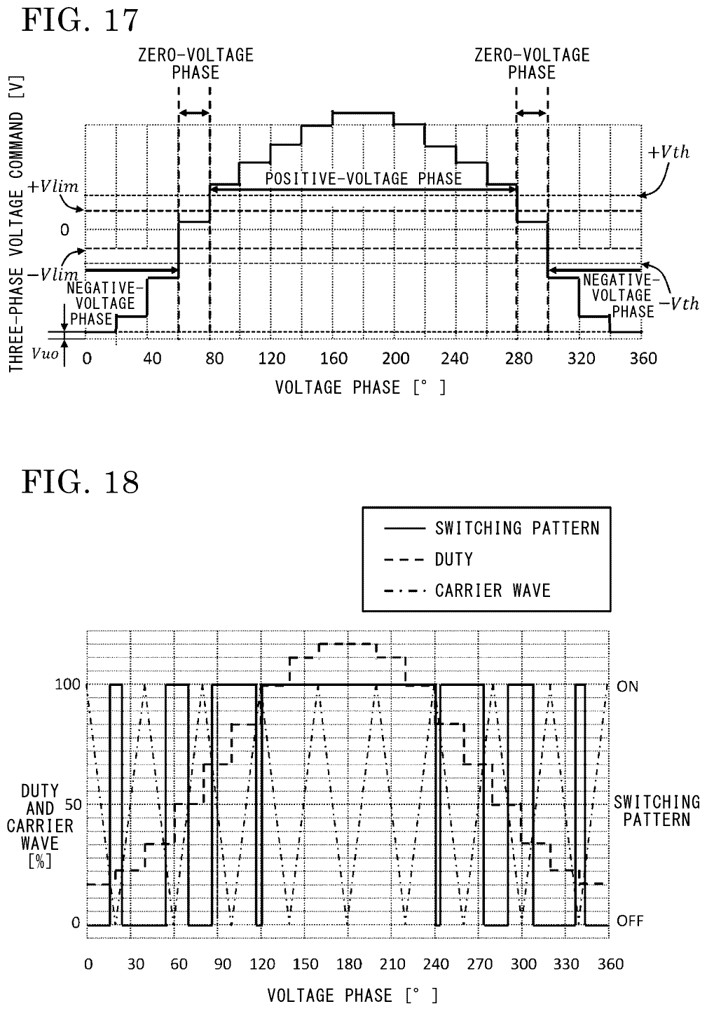

Correction determination for the first corrected three-phase voltage command P10 will be described. FIG. 17 illustrates correction determination for the first corrected three-phase voltage command according to embodiment 2. FIG. 17 is for u phase, and the same applies to v phase and w phase. As in embodiment 1, also in correction determination for the first corrected three-phase voltage command P10, which the voltage phase of the first corrected three-phase voltage command P10 is among a “zero-voltage phase”, a “positive-voltage phase”, and a “negative-voltage phase”, is determined, and on the basis of the determination result, correction determination is performed. Here, the first corrected three-phase voltage command P10 is in a state in which the entirety of the three-phase voltage command P3 is offset by the three-phase voltage command correction amount P15 (in a case of u phase, the u-phase voltage command correction amount Vuo), and therefore the voltage phase P2 that becomes a “zero-voltage phase” might be changed. Meanwhile, if offset by the first three-phase voltage command correction unit 28 is extremely great, the voltage phase P2 that should be originally determined to be a “zero-voltage phase” might be determined to be a “positive-voltage phase” or a “negative-voltage phase”, so that correction determination cannot be performed appropriately. It is also conceivable that correction determination is performed with offset by the first three-phase voltage command correction unit 28 taken into consideration, but in this case, correction determination is complicated. Therefore, it is preferable that offset correction by the first three-phase voltage command correction unit 28 does not influence correction determination in the first corrected three-phase voltage command correction determination unit 22 and appropriate correction determination is ensured.

As a method for ensuring appropriate correction determination, the following method is conceivable. That is, first, a predetermined threshold Vth is set. The value of the threshold Vth is a predetermined positive value, and hereinafter, the value of the threshold Vth may be simply referred to as Vth. The voltage phase P2 when the value of the first corrected three-phase voltage command P10 (in a case of u phase, the first corrected u-phase voltage command Vu*1) is in a range not smaller than −Vth and not greater than +Vth (−Vth≤Vu*1≤+Vth) is determined to be a “zero-voltage phase”, the voltage phase P2 when the value of the first corrected three-phase voltage command P10 (first corrected u-phase voltage command Vu*1) is greater than +Vth (Vu*1>+Vth) is determined to be a “positive-voltage phase”, and the voltage phase P2 when the value of the first corrected three-phase voltage command P10 (first corrected u-phase voltage command Vu*1) is smaller than −Vth (Vu*1<−Vth) is determined to be a “negative-voltage phase”. In the example shown in FIG. 17, if the value of the voltage phase is 0° to 60° or 300° to 360°, the voltage phase is determined to be a “negative-voltage phase”, and if the value of the voltage phase is 60° to 80° or 280° to 300°, the voltage phase is determined to be a “zero-voltage phase”. In addition, if the value of the voltage phase is 80° to 280°, the voltage phase is determined to be a “positive-voltage phase”.

In order to appropriately perform correction determination, it is also necessary to appropriately perform determination for a “zero-voltage phase”, a “positive-voltage phase”, and a “negative-voltage phase”. Therefore, it is preferable that the offset amount for the first corrected three-phase voltage command P10 (first corrected u-phase voltage command Vu*1), i.e., the three-phase voltage command correction amount P15 (u-phase voltage command correction amount Vuo), is in such a range that does not influence determination for a “zero-voltage phase” and the like. That is, it is preferable that the upper limit value Vlim used in calculation of the three-phase voltage command correction amount P15 is smaller than the threshold Vth used for determination for a “zero-voltage phase” and the like. By setting the upper limit value Vlim to be smaller than the threshold Vth, it is possible to prevent erroneous determination in which, for example, the voltage phase that should be determined to be a “positive-voltage phase” is determined to be a “zero-voltage phase”. In addition, correction determination is not complicated.

In embodiment 2, only one upper limit value Vlim is set and the sign thereof is changed, thereby adapting to each of positive and negative sides. However, an upper limit value (for a negative side, a lower limit value) may be individually set for each of positive and negative sides. That is, an upper limit value for positive side may be set as Vlim1 (Vlim1>0) and a lower limit value for negative side may be set as Vlim2 (Vlim2<0). Similarly, also regarding the threshold Vth, a threshold for positive side may be set as Vth1 (Vth1>0) and a threshold for negative side may be set as Vth2 (Vth2<0). The threshold Vth1 for positive side needs to be not greater than the minimum value of the three-phase voltage command when the voltage phase is determined to be a positive-voltage phase. The threshold Vth2 for negative phase needs to be not smaller than the maximum value of the three-phase voltage command when the voltage phase is determined to be a negative-voltage phase.

The second three-phase voltage command correction unit 29 receives the correction determination result P14 from the first corrected three-phase voltage command correction determination unit 22, and the first corrected three-phase voltage command P10 from the first three-phase voltage command correction unit 28. In addition, the second three-phase voltage command correction unit 29 receives the DC voltage signal SD from the power supply unit 82. On the basis of the correction determination result P14, the second three-phase voltage command correction unit 29 corrects the first corrected three-phase voltage command P10 using the DC voltage value Vdc, to calculate the second corrected three-phase voltage command P11. The second three-phase voltage command correction unit 29 outputs the second corrected three-phase voltage command P11 to the three-phase voltage command normalization unit 15. The second corrected three-phase voltage command P11 also includes voltage commands for u phase, v phase, and w phase. These voltage commands are referred to as a second corrected u-phase voltage command Vu*2, a second corrected v-phase voltage command Vv*2, and a second corrected w-phase voltage command Vw*2.

For the first corrected three-phase voltage command P10, in a case where the voltage phase P2 is determined to be a “zero-voltage phase”, the second three-phase voltage command correction unit 29 does not perform correction. For example, in a case of u phase, Vu*2 becomes equal to Vu*1. The same applies to v phase and w phase.

For the first corrected three-phase voltage command P10, in a case where the voltage phase P2 is determined to be a “positive-voltage phase”, the second three-phase voltage command correction unit 29 corrects the first corrected three-phase voltage command P10 so that the duty P7 becomes 100% or greater. Correction for making the duty P7 be 100% or greater is the same as in embodiment 1. For example, in a case of u phase, the first corrected u-phase voltage command Vu*1 is corrected to a value not smaller than Vref_MAX (=+Vdc/2). The same applies to v phase and w phase.

For the first corrected three-phase voltage command P10, in a case where the voltage phase P2 is determined to be a “negative-voltage phase”, the second three-phase voltage command correction unit 29 corrects the first corrected three-phase voltage command P10 so that the duty P7 becomes 0% or smaller. Correction for making the duty P7 be 0% or smaller is the same as in embodiment 1. For example, in a case of u phase, the first corrected u-phase voltage command Vu*1 is corrected to a value not greater than Vref_MIN (=−Vdc/2). The same applies to v phase and w phase.

The three-phase voltage command normalization unit 15 normalizes the second corrected three-phase voltage command P11, to generate the duty P7. A calculation method for the duty P7 is the same as in embodiment 1. The duty P7 is in a state of being offset in the amplitude direction through correction by the first three-phase voltage command correction unit 28 and being corrected to 100% or greater or to 0% or smaller at a “positive-voltage phase” or a “negative-voltage phase”, respectively, through correction by the second three-phase voltage command correction unit 29. The carrier wave generation unit 16 and the PWM control unit 17 are the same as those in embodiment 1.

FIG. 18 shows an example of the relationship among the duty, the carrier wave, and the switching pattern according to embodiment 2, in a case where the duty is calculated without correction of the first corrected three-phase voltage command. In FIG. 18, the switching pattern is indicated by a solid line, and the duty is indicated by a broken line. The carrier wave is indicated by a dotted-dashed line. The “duty”, the “carrier wave”, and the “switching pattern” in FIG. 18 represent those for any of u phase, v phase, and w phase. As is found from FIG. 18, the duty P7 calculated in a case where the three-phase voltage command (first corrected three-phase voltage command P10) not corrected by the second three-phase voltage command correction unit 29 is normalized, has a sinewave shape the entirety of which is offset in the positive direction. In the example shown in FIG. 18, the carrier wave frequency is nine times the electric angle frequency (equal to the frequency of the three-phase voltage command). In this case, the duty P7 is calculated in half the cycle of the carrier wave P8. Also in FIG. 18, it is found that calculation for updating the duty P7 is performed at timings of a crest and a trough of the carrier wave P8.

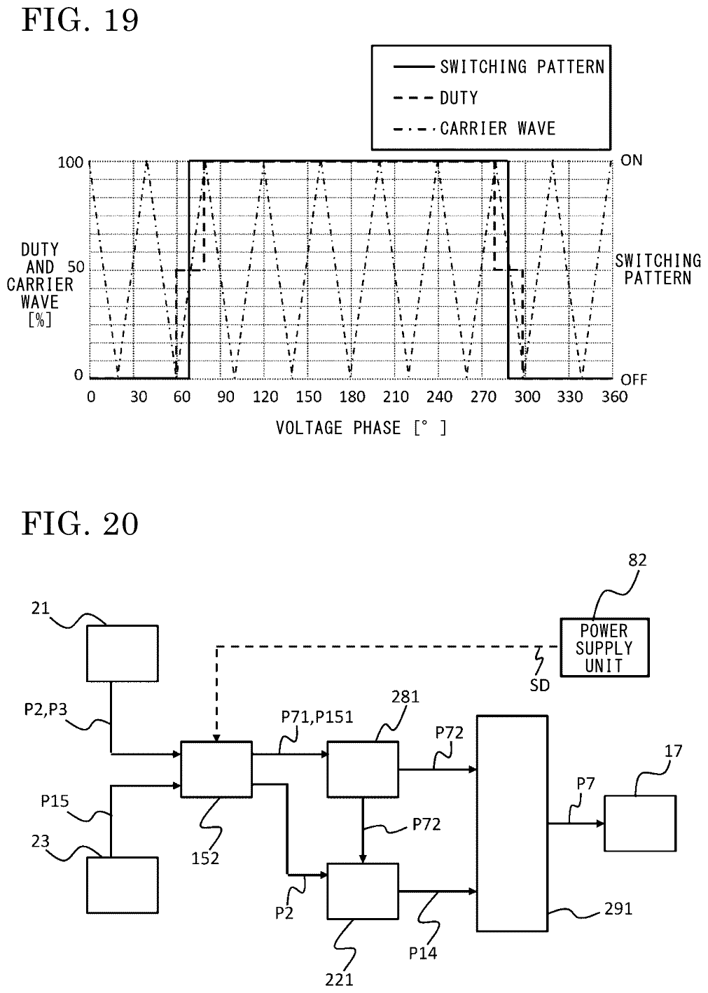

FIG. 19 shows an example of the relationship among the duty, the carrier wave, and the switching pattern according to embodiment 2, in a case where the duty is calculated with the first corrected three-phase voltage command corrected. As is found from FIG. 19, the duty P7 calculated in a case where the three-phase voltage command (second corrected three-phase voltage command P11) corrected by the second three-phase voltage command correction unit 29 is normalized, has a value corresponding to each of a “positive-voltage phase”, a “zero-voltage phase”, and a “negative-voltage phase”, and thus becomes 100% or greater, 50%, or 0% or smaller, depending on the voltage phase. Here, in comparison with the carrier wave P8, there is no problem if 100% or greater is regarded as 100% and 0% or smaller is regarded as 0%. As shown in FIG. 19, the switching pattern P9 obtained by comparing the duty P7 calculated from the second corrected three-phase voltage command P11 with the carrier wave P8 has a rectangular wave shape, and thus rectangular wave control is realized. The number of times of ON-OFF repetition in the switching pattern P9 in one cycle of electric angle is only one.

As described above, also in a case where offset by the three-phase voltage command correction amount P15 is performed first and then correction determination based on the voltage phase is performed, it is possible to adjust ON/OFF switchover timings of the switching pattern P9 and adjust ON/OFF switchover timings of rectangular wave voltage supplied to the rotating machine 900, as in embodiment 1.

A hardware configuration for implementing the inverter control unit 20 is the same as that for the inverter control unit 20 in embodiment 1. Also, the other matters are the same as in embodiment 1 and therefore the description thereof is omitted.

In embodiment 2, correction by the first three-phase voltage command correction unit 28 and correction by the second three-phase voltage command correction unit 29 are performed before normalization by the three-phase voltage command normalization unit 15. However, as in embodiment 1, normalization may be performed first. Hereinafter, this will be described.

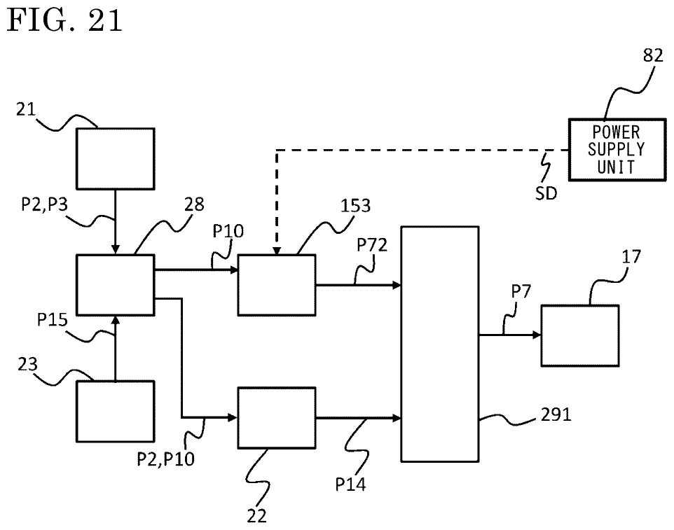

FIG. 20 illustrates an example in which the three-phase voltage command before correction is normalized to calculate a pre-correction duty and then correction is performed on the pre-correction duty, in embodiment 2. Among all the components shown in FIG. 16, only components needed for description are shown. A three-phase voltage command normalization unit 152 receives the voltage phase P2 and the three-phase voltage command P3 from the two-phase/three-phase conversion unit 21, and the three-phase voltage command correction amount P15 from the three-phase voltage command correction amount calculation unit 23. In addition, the three-phase voltage command normalization unit 152 receives the DC voltage signal SD from the power supply unit 82. The three-phase voltage command normalization unit 152 normalizes the three-phase voltage command P3 before correction and the three-phase voltage command correction amount P15, to calculate the pre-correction duty P71 which is a duty in which correction has not been reflected. Normalization of the three-phase voltage command P3 is the same as in the three-phase voltage command normalization unit 15. In addition, the three-phase voltage command normalization unit 152 normalizes the three-phase voltage command correction amount P15, to calculate a duty correction amount P151. Calculation of the duty correction amount P151 is the same as calculation of the duty correction amount P51 in embodiment 1. The duty correction amount P151 includes the u-phase duty correction amount Duo, the v-phase duty correction amount Dvo, and the w-phase duty correction amount Dwo. The three-phase voltage command normalization unit 152 outputs the pre-correction duty P71 and the duty correction amount P151 to a first duty correction unit 281. The three-phase voltage command normalization unit 152 outputs the voltage phase P2 to a first corrected duty correction determination unit 221.

The first duty correction unit 281 receives the pre-correction duty P71 and the duty correction amount P151 from the three-phase voltage command normalization unit 152. The first duty correction unit 281 corrects the pre-correction duty P71 on the basis of the duty correction amount P151, to calculate a first corrected duty P72. The first duty correction unit 281 outputs the first corrected duty P72 to the first corrected duty correction determination unit 221 and a second duty correction unit 291. The first corrected duty P72 also includes duties for u phase, v phase, and w phase. These duties are referred to as a first corrected u-phase duty Du*1, a first corrected v-phase duty Dv*1, and a first corrected w-phase duty Dw*1.

The first corrected duty correction determination unit 221 receives the voltage phase P2 from the three-phase voltage command normalization unit 152 and the first corrected duty P72 from the first duty correction unit 281. The first corrected duty correction determination unit 221 determines which the voltage phase P2 for each phase of the first corrected duty P72 is among a “zero-voltage phase”, a “positive-voltage phase”, and a “negative-voltage phase”, and on the basis of the determination result, performs correction determination. The first corrected duty correction determination unit 221 outputs the correction determination result P14 indicating the result of the correction determination, to the second duty correction unit 291.

The second duty correction unit 291 receives the correction determination result P14 from the first corrected duty correction determination unit 221 and the first corrected duty P72 from the first duty correction unit 281. The second duty correction unit 291 corrects the first corrected duty P72 on the basis of the correction determination result P14, to calculate the duty P7 in which correction has been reflected. The second duty correction unit 291 outputs the duty P7 to the PWM control unit 17. The subsequent operation is the same as in FIG. 16.

Correction of the first corrected duty P72 by the second duty correction unit 291 is as follows. For the first corrected duty P72, in a case where the voltage phase P2 is determined to be a “zero-voltage phase”, the second duty correction unit 291 does not perform correction. For the first corrected duty P72, in a case where the voltage phase P2 is determined to be a “positive-voltage phase”, the second duty correction unit 291 corrects the first corrected duty P72 to 100% or greater. For the first corrected duty P72, in a case where the voltage phase P2 is determined to be a “negative-voltage phase”, the second duty correction unit 291 corrects the first corrected duty P72 to 0% or smaller.

Here, it is conceivable that normalization is performed after calculation of the first corrected three-phase voltage command P10 and before calculation of the second corrected three-phase voltage command P11. FIG. 21 illustrates an example in which the first corrected three-phase voltage command is normalized to calculate the first corrected duty and then correction is further performed on the first corrected duty, in embodiment 2. Among all the components shown in FIG. 16, only components needed for description are shown. As in the example shown in FIG. 16, the first three-phase voltage command correction unit 28 receives the voltage phase P2 and the three-phase voltage command P3 from the two-phase/three-phase conversion unit 21, and the three-phase voltage command correction amount P15 from the three-phase voltage command correction amount calculation unit 23. The first three-phase voltage command correction unit 28 corrects the three-phase voltage command P3 on the basis of the three-phase voltage command correction amount P15, to calculate the first corrected three-phase voltage command P10. The first three-phase voltage command correction unit 28 outputs the voltage phase P2 and the first corrected three-phase voltage command P10 to the first corrected three-phase voltage command correction determination unit 22. In addition, the first three-phase voltage command correction unit 28 outputs the first corrected three-phase voltage command P10 to a first corrected three-phase voltage command normalization unit 153.

The first corrected three-phase voltage command normalization unit 153 receives the first corrected three-phase voltage command P10 from the first three-phase voltage command correction unit 28 and the DC voltage signal SD from the power supply unit 82. The first corrected three-phase voltage command normalization unit 153 normalizes the first corrected three-phase voltage command P10 for each phase, to calculate the first corrected duty P72. As in the example shown in FIG. 16, the first corrected three-phase voltage command correction determination unit 22 receives the voltage phase P2 and the first corrected three-phase voltage command P10 from the first three-phase voltage command correction unit 28, determines which the voltage phase P2 for each phase of the first corrected three-phase voltage command P10 is among a “zero-voltage phase”, a “positive-voltage phase”, and a “negative-voltage phase”, and on the basis of the determination result, performs correction determination for the first corrected three-phase voltage command P10. The first corrected three-phase voltage command correction determination unit 22 outputs the correction determination result P14 indicating the result of the correction determination, to the second duty correction unit 291. The second duty correction unit 291 is the same as in the example shown in FIG. 20. As in the example shown in FIG. 21, also in the configuration in which normalization is performed after calculation of the first corrected three-phase voltage command P10 and before calculation of the second corrected three-phase voltage command P11, the duty P7 in which correction has been reflected is calculated.

The correction determination result P14 does not change due to normalization by the first corrected three-phase voltage command normalization unit 153. That is, the voltage phase P2 that is determined to be a “zero-voltage phase” before normalization is also determined to be a “zero-voltage phase” after normalization. This is because, as is found from FIG. 4 and the like, if the first corrected three-phase voltage command before normalization is 0 V, the duty after normalization always becomes a duty of 50%. Therefore, although FIG. 21 shows the example in which correction determination is performed on the basis of the first corrected three-phase voltage command P10 and the voltage phase P2, correction determination may be performed on the basis of the first corrected duty P72 and the voltage phase P2. In this case, a voltage phase when the value of the first corrected duty P72 is determined to be 50% is determined to be a “zero-voltage phase”, a voltage phase when the value of the first corrected duty P72 is determined to be greater than 50% is determined to be a “positive-voltage phase”, and a voltage phase when the value of the first corrected duty P72 is determined to be smaller than 50% is determined to be a “negative-voltage phase”.

As described above, the order of offset correction of the entirety by the first three-phase voltage command correction unit, correction based on the correction determination result by the second three-phase voltage command correction unit, and normalization, may be changed. That is, also in embodiment 2, it suffices that the duty P7 in which correction has been reflected is compared with the carrier wave P8, to obtain the switching pattern P9.

Also in the cases where normalization is performed first as in the examples in FIG. 20 and FIG. 21, it is preferable that the three-phase voltage command correction amount P15 is in such a range that does not influence determination for a “zero-voltage phase” and the like, as described in FIG. 17.

Embodiment 2 can provide the same effects as embodiment 1.

In addition, in embodiment 2, before correction determination by the three-phase voltage command correction determination unit, offset correction in the amplitude direction by the three-phase voltage command correction amount is performed on the three-phase voltage command, to calculate the first corrected three-phase voltage command. Thus, correction determination based on the voltage phase can be performed appropriately. More specifically, a value not greater than a minimum value of the three-phase voltage command when the voltage phase is determined to be the positive-voltage phase is set as a positive-side threshold, and a maximum value of the three-phase voltage command when the voltage phase is determined to be the negative-voltage phase is set as a negative-side threshold. For the three-phase voltage command correction amount, a value smaller than the positive-side threshold is set as an upper limit value, and a value greater than the negative-side threshold is set as a lower limit value. Therefore, offset correction by the first three-phase voltage command correction unit is kept within such a range that does not influence correction determination for the first corrected three-phase voltage command based on the voltage command. Thus, erroneous determination in which, for example, the voltage phase that should be determined to be a “positive-voltage phase” is determined to be a “zero-voltage phase”, is prevented, and correction determination based on the voltage phase can be performed appropriately. In addition, correction determination is not complicated.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the present disclosure. For example, at least one of the constituent components may be modified, added, or eliminated.

Hereinafter, modes of the present disclosure are summarized as additional notes.

### (Additional Note 1)

A rotating machine control device which controls a rotating machine by applying rectangular wave voltage to the rotating machine, the rotating machine control device comprising:
an inverter which converts DC power and outputs the rectangular wave voltage;
an inverter control unit which generates a rectangular-wave-shaped switching pattern for controlling the inverter; and
a rotation position detection unit which detects a rotation position of the rotating machine, wherein
the inverter control unit includes
   a two-phase/three-phase conversion unit which, on the basis of the rotation position, converts a dq-axis voltage command to a three-phase voltage command and calculates a voltage phase of the three-phase voltage command,
   a three-phase voltage command normalization unit which normalizes the three-phase voltage command, to calculate a duty,
   a three-phase voltage command correction amount calculation unit which calculates a three-phase voltage command correction amount,
   a carrier wave generation unit which generates a carrier wave having a frequency that is an odd multiple of an electric angle frequency of the rotating machine, and
   a switching pattern generation unit which generates the switching pattern by comparing the duty with the carrier wave,
the inverter control unit determines a correction method for the duty in accordance with which the voltage phase is among a zero-voltage phase which is the voltage phase when the three-phase voltage command is determined to be zero, a positive-voltage phase which is the voltage phase when the three-phase voltage command is determined to be positive, and a negative-voltage phase which is the voltage phase when the three-phase voltage command is determined to be negative,
in a case where the voltage phase is determined to be the zero-voltage phase, the inverter control unit performs correction of offsetting the duty in an amplitude direction on the basis of the three-phase voltage command correction amount,
in a case where the voltage phase is determined to be the positive-voltage phase, the inverter control unit performs correction of making the duty be 100% or greater, and
in a case where the voltage phase is determined to be the negative-voltage phase, the inverter control unit performs correction of making the duty be 0% or smaller.

### (Additional Note 2)

The rotating machine control device according to additional note 1, wherein
the inverter control unit further includes
   a correction determination unit which determines a correction method for the three-phase voltage command in accordance with which the voltage phase is among the zero-voltage phase, the positive-voltage phase, and the negative-voltage phase, and outputs a correction determination result, and
   a three-phase voltage command correction unit which corrects the three-phase voltage command on the basis of the correction determination result, to calculate a corrected three-phase voltage command,
the three-phase voltage command normalization unit normalizes the corrected three-phase voltage command, to calculate the duty,
in a case where the voltage phase is determined to be the zero-voltage phase, the three-phase voltage command correction unit performs correction of adding or subtracting the three-phase voltage command correction amount to or from the three-phase voltage command,
in a case where the voltage phase is determined to be the positive-voltage phase, the three-phase voltage command correction unit corrects the three-phase voltage command to such a value that the duty becomes 100% or greater, and
in a case where the voltage phase is determined to be the negative-voltage phase, the three-phase voltage command correction unit corrects the three-phase voltage command to such a value that the duty becomes 0% or smaller.

### (Additional Note 3)

A rotating machine control device which controls a rotating machine by applying rectangular wave voltage to the rotating machine, the rotating machine control device comprising:
an inverter which converts DC power and outputs the rectangular wave voltage;
an inverter control unit which generates a rectangular-wave-shaped switching pattern for controlling the inverter; and
a rotation position detection unit which detects a rotation position of the rotating machine, wherein
the inverter control unit includes
   a two-phase/three-phase conversion unit which, on the basis of the rotation position, converts a dq-axis voltage command to a three-phase voltage command and calculates a voltage phase of the three-phase voltage command,
   a three-phase voltage command normalization unit which normalizes the three-phase voltage command, to calculate a duty,
   a three-phase voltage command correction amount calculation unit which calculates a three-phase voltage command correction amount,
   a first three-phase voltage command correction unit which performs correction of offsetting the three-phase voltage command in an amplitude direction on the basis of the three-phase voltage command correction amount, to calculate a first corrected three-phase voltage command,
   a carrier wave generation unit which generates a carrier wave having a frequency that is an odd multiple of an electric angle frequency of the rotating machine, and
   a switching pattern generation unit which generates the switching pattern by comparing the duty with the carrier wave,
the inverter control unit determines a correction method for the duty in accordance with which the voltage phase is among a zero-voltage phase which is the voltage phase when the first corrected three-phase voltage command is determined to be zero, a positive-voltage phase which is the voltage phase when the first corrected three-phase voltage command is determined to be positive, and a negative-voltage phase which is the voltage phase when the first corrected three-phase voltage command is determined to be negative,
in a case where the voltage phase is determined to be the zero-voltage phase, the inverter control unit does not correct the duty,
in a case where the voltage phase is determined to be the positive-voltage phase, the inverter control unit performs correction of making the duty be 100% or greater, and
in a case where the voltage phase is determined to be the negative-voltage phase, the inverter control unit performs correction of making the duty be 0% or smaller.

### (Additional Note 4)

The rotating machine control device according to additional note 3, wherein
the inverter control unit further includes
   a correction determination unit which determines a correction method for the first corrected three-phase voltage command in accordance with which the voltage phase is among the zero-voltage phase, the positive-voltage phase, and the negative-voltage phase, and outputs a correction determination result, and
   a second three-phase voltage command correction unit which corrects the first corrected three-phase voltage command on the basis of the correction determination result, to calculate a corrected three-phase voltage command,
the three-phase voltage command normalization unit normalizes the corrected three-phase voltage command, to calculate the duty,
in a case where the voltage phase is determined to be the zero-voltage phase, the second three-phase voltage command correction unit does not correct the first corrected three-phase voltage command,
in a case where the voltage phase is determined to be the positive-voltage phase, the second three-phase voltage command correction unit corrects the first corrected three-phase voltage command to such a value that the duty becomes 100% or greater, and
in a case where the voltage phase is determined to be the negative-voltage phase, the second three-phase voltage command correction unit corrects the first corrected three-phase voltage command to such a value that the duty becomes 0% or smaller.

### (Additional Note 5)

The rotating machine control device according to additional note 3 or 4, wherein
a value not greater than a minimum value of the three-phase voltage command when the voltage phase is determined to be the positive-voltage phase is set as a positive-side threshold, and a value not smaller than a maximum value of the three-phase voltage command when the voltage phase is determined to be the negative-voltage phase is set as a negative-side threshold, and
for the three-phase voltage command correction amount, a value smaller than the positive-side threshold is set as an upper limit value, and a value greater than the negative-side threshold is set as a lower limit value.

### (Additional Note 6)

The rotating machine control device according to any one of additional notes 1 to 5, further comprising an output current detection unit which detects three-phase current flowing between the inverter and the rotating machine, wherein
the three-phase voltage command correction amount calculation unit calculates the three-phase voltage command correction amount so as to reduce an offset component of the three-phase current, on the basis of the three-phase current.

### (Additional Note 7)

The rotating machine control device according to additional note 6, wherein
the three-phase voltage command correction amount calculation unit calculates the three-phase voltage command correction amount through such feedback control that makes an integral value of the three-phase current close to zero.

### (Additional Note 8)

The rotating machine control device according to any one of additional notes 1 to 7, wherein
the three-phase voltage command correction amount calculation unit calculates the three-phase voltage command correction amount by multiplying a fixed value set in advance as a correction amount for the rectangular wave voltage by a proportional gain based on a value obtained by dividing the frequency of the carrier wave by the electric angle frequency.

### (Additional Note 9)

The rotating machine control device according to any one of additional notes 1 to 8, further comprising a voltage detection unit which detects a DC voltage value of the DC power supplied to the inverter, wherein
in a case where the voltage phase is determined to be the positive-voltage phase, the inverter control unit corrects the three-phase voltage command to a first voltage value determined on the basis of the DC voltage value, to make the duty be 100% or greater, and
in a case where the voltage phase is determined to be the negative-voltage phase, the inverter control unit corrects the three-phase voltage command to a second voltage value determined on the basis of the DC voltage value, to make the duty be 0% or smaller.

### (Additional Note 10)

The rotating machine control device according to additional note 9, wherein
in a case where the voltage phase is determined to be the positive-voltage phase, the inverter control unit multiplies the three-phase voltage command by a predetermined first gain, to make the duty be 100% or greater,
in a case where the voltage phase is determined to be the negative-voltage phase, the inverter control unit multiplies the three-phase voltage command by a predetermined second gain, to make the duty be 0% or smaller, and
the first gain and the second gain are set on the basis of the DC voltage value.

### (Additional Note 11)

The rotating machine control device according to any one of additional notes 1 to 10, wherein
a value obtained by dividing the frequency of the carrier wave by the electric angle frequency is an odd multiple of 3.

### (Additional Note 12)

The rotating machine control device according to any one of additional notes 1 to 11, wherein
the zero-voltage phase includes a first zero-voltage phase that arises when the three-phase voltage command switches from negative to positive, and a second zero-voltage phase that arises when the three-phase voltage command switches from positive to negative, and
a value of the three-phase voltage command correction amount corresponding to the first zero-voltage phase and a value of the three-phase voltage command correction amount corresponding to the second zero-voltage phase are different from each other.

### (Additional Note 13)

The rotating machine control device according to additional note 1, wherein
the inverter control unit further includes
   a correction determination unit which determines a correction method for the duty in accordance with which the voltage phase is among the zero-voltage phase, the positive-voltage phase, and the negative-voltage phase, and outputs a correction determination result, and
   a duty correction unit which corrects the duty on the basis of the correction determination result,
the three-phase voltage command normalization unit normalizes the three-phase voltage command before correction, to calculate the duty, and normalizes the three-phase voltage command correction amount, to calculate a duty correction amount,
in a case where the voltage phase is determined to be the zero-voltage phase, the duty correction unit performs correction of adding or subtracting the duty correction amount to or from the duty,
in a case where the voltage phase is determined to be the positive-voltage phase, the duty correction unit corrects the duty to 100% or greater, and
in a case where the voltage phase is determined to be the negative-voltage phase, the duty correction unit corrects the duty to 0% or smaller.

### (Additional Note 14)

The rotating machine control device according to additional note 3, wherein
the three-phase voltage command normalization unit normalizes the first corrected three-phase voltage command, to calculate the duty,
the inverter control unit further includes
   a correction determination unit which determines a correction method for the duty in accordance with which the voltage phase is among the zero-voltage phase, the positive-voltage phase, and the negative-voltage phase, and outputs a correction determination result, and
   a duty correction unit which corrects the duty on the basis of the correction determination result,
in a case where the voltage phase is determined to be the zero-voltage phase, the duty correction unit does not correct the duty,
in a case where the voltage phase is determined to be the positive-voltage phase, the duty correction unit corrects the duty to 100% or greater, and
in a case where the voltage phase is determined to be the negative-voltage phase, the duty correction unit corrects the duty to 0% or smaller.

### (Additional Note 15)

The rotating machine control device according to additional note 3, wherein
the three-phase voltage command normalization unit normalizes the three-phase voltage command, to calculate the duty, and normalizes the three-phase voltage command correction amount, to calculate a duty correction amount,
the first three-phase voltage command correction unit is a first duty correction unit which performs correction of adding or subtracting the duty correction amount to or from the duty, to calculate a first corrected duty which is the first corrected three-phase voltage command that has been normalized,
the inverter control unit further includes
   a correction determination unit which determines a correction method for the first corrected duty in accordance with which the voltage phase is among the zero-voltage phase, the positive-voltage phase, and the negative-voltage phase, and outputs a correction determination result, and
   a second duty correction unit which corrects the first corrected duty on the basis of the correction determination result,
in a case where the voltage phase is determined to be the zero-voltage phase, the second duty correction unit does not correct the first corrected duty,
in a case where the voltage phase is determined to be the positive-voltage phase, the second duty correction unit corrects the first corrected duty to 100% or greater, and
in a case where the voltage phase is determined to be the negative-voltage phase, the second duty correction unit corrects the first corrected duty to 0% or smaller.

### DESCRIPTION OF THE REFERENCE CHARACTERS

10, 20 inverter control unit
11, 21 two-phase/three-phase conversion unit
12 three-phase voltage command correction determination unit
13, 23 three-phase voltage command correction amount calculation unit
14 three-phase voltage command correction unit
15, 151, 152 three-phase voltage command normalization unit
16 carrier wave generation unit
17 PWM control unit
22 first corrected three-phase voltage command correction determination unit
28 first three-phase voltage command correction unit
29 second three-phase voltage command correction unit
81 inverter
82 power supply unit
83 output current detection unit
100, 200 rotating machine control device
141 duty correction unit
153 first corrected three-phase voltage command normalization unit
221 first corrected duty correction determination unit
281 first duty correction unit
291 second duty correction unit
900 rotating machine
901 rotation position detection unit
DC DC power
P1 dq-axis voltage command
P2 voltage phase
P3 three-phase voltage command
P4, P14 correction determination result
P5, P15 three-phase voltage command correction amount
P6 corrected three-phase voltage command
P7 duty
P8 carrier wave
P9, P19 switching pattern
P10 first corrected three-phase voltage command
P11 second corrected three-phase voltage command
P51, P151 duty correction amount
P71 pre-correction duty
P72 first corrected duty
SC three-phase current signal
SD DC voltage signal
SR rotation position signal

1. A rotating machine control device which controls a rotating machine by applying rectangular wave voltage to the rotating machine, the rotating machine control device comprising:
an inverter which converts DC power and outputs the rectangular wave voltage;
an inverter control circuitry which generates a rectangular-wave-shaped switching pattern for controlling the inverter; and
a rotation position detection circuitry which detects a rotation position of the rotating machine, wherein
the inverter control circuitry includes
a two-phase/three-phase conversion circuitry which, on the basis of the rotation position, converts a dq-axis voltage command to a three-phase voltage command and calculates a voltage phase of the three-phase voltage command,
a three-phase voltage command normalization circuitry which normalizes the three-phase voltage command, to calculate a duty,
a three-phase voltage command correction amount calculation circuitry which calculates a three-phase voltage command correction amount,
a carrier wave generation circuitry which generates a carrier wave having a frequency that is an odd multiple of an electric angle frequency of the rotating machine, and
a switching pattern generation circuitry which generates the switching pattern by comparing the duty with the carrier wave,
the inverter control circuitry determines a correction method for the duty in accordance with which the voltage phase is among a zero-voltage phase which is the voltage phase when the three-phase voltage command is determined to be zero, a positive-voltage phase which is the voltage phase when the three-phase voltage command is determined to be positive, and a negative-voltage phase which is the voltage phase when the three-phase voltage command is determined to be negative,
in a case where the voltage phase is determined to be the zero-voltage phase, the inverter control circuitry performs correction of offsetting the duty in an amplitude direction on the basis of the three-phase voltage command correction amount,
in a case where the voltage phase is determined to be the positive-voltage phase, the inverter control circuitry performs correction of making the duty be 100% or greater, and
in a case where the voltage phase is determined to be the negative-voltage phase, the inverter control circuitry performs correction of making the duty be 0% or smaller.

2. The rotating machine control device according to claim 1, wherein
the inverter control circuitry further includes
a correction determination circuitry which determines a correction method for the three-phase voltage command in accordance with which the voltage phase is among the zero-voltage phase, the positive-voltage phase, and the negative-voltage phase, and outputs a correction determination result, and
a three-phase voltage command correction circuitry which corrects the three-phase voltage command on the basis of the correction determination result, to calculate a corrected three-phase voltage command,
the three-phase voltage command normalization circuitry normalizes the corrected three-phase voltage command, to calculate the duty,
in a case where the voltage phase is determined to be the zero-voltage phase, the three-phase voltage command correction circuitry performs correction of adding or subtracting the three-phase voltage command correction amount to or from the three-phase voltage command,
in a case where the voltage phase is determined to be the positive-voltage phase, the three-phase voltage command correction circuitry corrects the three-phase voltage command to such a value that the duty becomes 100% or greater, and
in a case where the voltage phase is determined to be the negative-voltage phase, the three-phase voltage command correction circuitry corrects the three-phase voltage command to such a value that the duty becomes 0% or smaller.

3. A rotating machine control device which controls a rotating machine by applying rectangular wave voltage to the rotating machine, the rotating machine control device comprising:
an inverter which converts DC power and outputs the rectangular wave voltage;
an inverter control circuitry which generates a rectangular-wave-shaped switching pattern for controlling the inverter; and
a rotation position detection circuitry which detects a rotation position of the rotating machine, wherein
the inverter control circuitry includes
a two-phase/three-phase conversion circuitry which, on the basis of the rotation position, converts a dq-axis voltage command to a three-phase voltage command and calculates a voltage phase of the three-phase voltage command,
a three-phase voltage command normalization circuitry which normalizes the three-phase voltage command, to calculate a duty,
a three-phase voltage command correction amount calculation circuitry which calculates a three-phase voltage command correction amount,
a first three-phase voltage command correction circuitry which performs correction of offsetting the three-phase voltage command in an amplitude direction on the basis of the three-phase voltage command correction amount, to calculate a first corrected three-phase voltage command,
a carrier wave generation circuitry which generates a carrier wave having a frequency that is an odd multiple of an electric angle frequency of the rotating machine, and
a switching pattern generation circuitry which generates the switching pattern by comparing the duty with the carrier wave,
the inverter control circuitry determines a correction method for the duty in accordance with which the voltage phase is among a zero-voltage phase which is the voltage phase when the first corrected three-phase voltage command is determined to be zero, a positive-voltage phase which is the voltage phase when the first corrected three-phase voltage command is determined to be positive, and a negative-voltage phase which is the voltage phase when the first corrected three-phase voltage command is determined to be negative,
in a case where the voltage phase is determined to be the zero-voltage phase, the inverter control circuitry does not correct the duty,
in a case where the voltage phase is determined to be the positive-voltage phase, the inverter control circuitry performs correction of making the duty be 100% or greater, and
in a case where the voltage phase is determined to be the negative-voltage phase, the inverter control circuitry performs correction of making the duty be 0% or smaller.

4. The rotating machine control device according to claim 3, wherein
the inverter control circuitry further includes
a correction determination circuitry which determines a correction method for the first corrected three-phase voltage command in accordance with which the voltage phase is among the zero-voltage phase, the positive-voltage phase, and the negative-voltage phase, and outputs a correction determination result, and
a second three-phase voltage command correction circuitry which corrects the first corrected three-phase voltage command on the basis of the correction determination result, to calculate a corrected three-phase voltage command,
the three-phase voltage command normalization circuitry normalizes the corrected three-phase voltage command, to calculate the duty,
in a case where the voltage phase is determined to be the zero-voltage phase, the second three-phase voltage command correction circuitry does not correct the first corrected three-phase voltage command,
in a case where the voltage phase is determined to be the positive-voltage phase, the second three-phase voltage command correction circuitry corrects the first corrected three-phase voltage command to such a value that the duty becomes 100% or greater, and
in a case where the voltage phase is determined to be the negative-voltage phase, the second three-phase voltage command correction circuitry corrects the first corrected three-phase voltage command to such a value that the duty becomes 0% or smaller.

5. The rotating machine control device according to claim 3, wherein
a value not greater than a minimum value of the three-phase voltage command when the voltage phase is determined to be the positive-voltage phase is set as a positive-side threshold, and a value not smaller than a maximum value of the three-phase voltage command when the voltage phase is determined to be the negative-voltage phase is set as a negative-side threshold, and
for the three-phase voltage command correction amount, a value smaller than the positive-side threshold is set as an upper limit value, and a value greater than the negative-side threshold is set as a lower limit value.

6. The rotating machine control device according to claim 1, further comprising an output current detection circuitry which detects three-phase current flowing between the inverter and the rotating machine, wherein
the three-phase voltage command correction amount calculation circuitry calculates the three-phase voltage command correction amount so as to reduce an offset component of the three-phase current, on the basis of the three-phase current.

7. The rotating machine control device according to claim 6, wherein
the three-phase voltage command correction amount calculation circuitry calculates the three-phase voltage command correction amount through such feedback control that makes an integral value of the three-phase current close to zero.

8. The rotating machine control device according to claim 1, wherein
the three-phase voltage command correction amount calculation circuitry calculates the three-phase voltage command correction amount by multiplying a fixed value set in advance as a correction amount for the rectangular wave voltage by a proportional gain based on a value obtained by dividing the frequency of the carrier wave by the electric angle frequency.

9. The rotating machine control device according to claim 1, further comprising a voltage detection circuitry which detects a DC voltage value of the DC power supplied to the inverter, wherein
in a case where the voltage phase is determined to be the positive-voltage phase, the inverter control circuitry corrects the three-phase voltage command to a first voltage value determined on the basis of the DC voltage value, to make the duty be 100% or greater, and
in a case where the voltage phase is determined to be the negative-voltage phase, the inverter control circuitry corrects the three-phase voltage command to a second voltage value determined on the basis of the DC voltage value, to make the duty be 0% or smaller.

10. The rotating machine control device according to claim 9, wherein
in a case where the voltage phase is determined to be the positive-voltage phase, the inverter control circuitry multiplies the three-phase voltage command by a predetermined first gain, to make the duty be 100% or greater,
in a case where the voltage phase is determined to be the negative-voltage phase, the inverter control circuitry multiplies the three-phase voltage command by a predetermined second gain, to make the duty be 0% or smaller, and
the first gain and the second gain are set on the basis of the DC voltage value.

11. The rotating machine control device according to claim 1, wherein
a value obtained by dividing the frequency of the carrier wave by the electric angle frequency is an odd multiple of 3.

12. The rotating machine control device according to claim 1, wherein
the zero-voltage phase includes a first zero-voltage phase that arises when the three-phase voltage command switches from negative to positive, and a second zero-voltage phase that arises when the three-phase voltage command switches from positive to negative, and
a value of the three-phase voltage command correction amount corresponding to the first zero-voltage phase and a value of the three-phase voltage command correction amount corresponding to the second zero-voltage phase are different from each other.

13. The rotating machine control device according to claim 1, wherein
the inverter control circuitry further includes
a correction determination circuitry which determines a correction method for the duty in accordance with which the voltage phase is among the zero-voltage phase, the positive-voltage phase, and the negative-voltage phase, and outputs a correction determination result, and
a duty correction circuitry which corrects the duty on the basis of the correction determination result,
the three-phase voltage command normalization circuitry normalizes the three-phase voltage command before correction, to calculate the duty, and normalizes the three-phase voltage command correction amount, to calculate a duty correction amount,
in a case where the voltage phase is determined to be the zero-voltage phase, the duty correction circuitry performs correction of adding or subtracting the duty correction amount to or from the duty,
in a case where the voltage phase is determined to be the positive-voltage phase, the duty correction circuitry corrects the duty to 100% or greater, and
in a case where the voltage phase is determined to be the negative-voltage phase, the duty correction circuitry corrects the duty to 0% or smaller.

14. The rotating machine control device according to claim 3, wherein
the three-phase voltage command normalization circuitry normalizes the first corrected three-phase voltage command, to calculate the duty,
the inverter control circuitry further includes
a correction determination circuitry which determines a correction method for the duty in accordance with which the voltage phase is among the zero-voltage phase, the positive-voltage phase, and the negative-voltage phase, and outputs a correction determination result, and
a duty correction circuitry which corrects the duty on the basis of the correction determination result,
in a case where the voltage phase is determined to be the zero-voltage phase, the duty correction circuitry does not correct the duty,
in a case where the voltage phase is determined to be the positive-voltage phase, the duty correction circuitry corrects the duty to 100% or greater, and
in a case where the voltage phase is determined to be the negative-voltage phase, the duty correction circuitry corrects the duty to 0% or smaller.

15. The rotating machine control device according to claim 3, wherein
the three-phase voltage command normalization circuitry normalizes the three-phase voltage command, to calculate the duty, and normalizes the three-phase voltage command correction amount, to calculate a duty correction amount,
the first three-phase voltage command correction circuitry is a first duty correction circuitry which performs correction of adding or subtracting the duty correction amount to or from the duty, to calculate a first corrected duty which is the first corrected three-phase voltage command that has been normalized,
the inverter control circuitry further includes
a correction determination circuitry which determines a correction method for the first corrected duty in accordance with which the voltage phase is among the zero-voltage phase, the positive-voltage phase, and the negative-voltage phase, and outputs a correction determination result, and
a second duty correction circuitry which corrects the first corrected duty on the basis of the correction determination result,
in a case where the voltage phase is determined to be the zero-voltage phase, the second duty correction circuitry does not correct the first corrected duty,
in a case where the voltage phase is determined to be the positive-voltage phase, the second duty correction circuitry corrects the first corrected duty to 100% or greater, and
in a case where the voltage phase is determined to be the negative-voltage phase, the second duty correction circuitry corrects the first corrected duty to 0% or smaller.

16. The rotating machine control device according to claim 3, further comprising an output current detection circuitry which detects three-phase current flowing between the inverter and the rotating machine, wherein
the three-phase voltage command correction amount calculation circuitry calculates the three-phase voltage command correction amount so as to reduce an offset component of the three-phase current, on the basis of the three-phase current.

17. The rotating machine control device according to claim 3, wherein
the three-phase voltage command correction amount calculation circuitry calculates the three-phase voltage command correction amount by multiplying a fixed value set in advance as a correction amount for the rectangular wave voltage by a proportional gain based on a value obtained by dividing the frequency of the carrier wave by the electric angle frequency.

18. The rotating machine control device according to claim 3, further comprising a voltage detection circuitry which detects a DC voltage value of the DC power supplied to the inverter, wherein
in a case where the voltage phase is determined to be the positive-voltage phase, the inverter control circuitry corrects the three-phase voltage command to a first voltage value determined on the basis of the DC voltage value, to make the duty be 100% or greater, and
in a case where the voltage phase is determined to be the negative-voltage phase, the inverter control circuitry corrects the three-phase voltage command to a second voltage value determined on the basis of the DC voltage value, to make the duty be 0% or smaller.

19. The rotating machine control device according to claim 3, wherein
a value obtained by dividing the frequency of the carrier wave by the electric angle frequency is an odd multiple of 3.

20. The rotating machine control device according to claim 3, wherein
the zero-voltage phase includes a first zero-voltage phase that arises when the three-phase voltage command switches from negative to positive, and a second zero-voltage phase that arises when the three-phase voltage command switches from positive to negative, and
a value of the three-phase voltage command correction amount corresponding to the first zero-voltage phase and a value of the three-phase voltage command correction amount corresponding to the second zero-voltage phase are different from each other.
